(19) United States
(12) Patent Application Publication
(10) Pub. No.: US 2024/0152785 A1
(43) Pub. Date: May 9, 2024

(54) Logic-Based System for Filtering Arguments

(71) Applicant: Peter Buchak, Wynnewood, PA (US)

(72) Inventor: Peter Buchak, Wynnewood, PA (US)

(21) Appl. No.: 18/504,341

(22) Filed: Nov. 8, 2023

Related U.S. Application Data
(60) Provisional application No. 63/382,774, filed on Nov. 8, 2022.

(51) Int. Cl. G06N 5/04

(52) U.S. Cl. CPC G06N 5/04

(57) ABSTRACT

Debaters encode the logical structure of their arguments in a framework designed so that these arguments can be processed by a computer. A system uses this structure to algorithmically identify logical contradictions and disputed points—places where one debater's views would make another debater's views obviously impossible. The disputed points are represented as short questions whose answers distinguish which debater is right. An end user is presented with these questions, and the user's answers are used to filter out debaters whose views are impossible. The user doesn't need to actually read the debaters' arguments, but can find out which views are right just by answering the questions that have been presented.

### BACKGROUND

When reading online discussion forums, users must sift through the perspectives of many people in order to make their judgment about who is correct. These perspectives are contained in posts that often also contain fallacies, side conversations, jokes, etc. When there are thousands of people posting, sifting through these posts could be a massive challenge that could in theory take a lifetime to accomplish. This is wasteful of both people's time—they have to read and think about a lot of information—and computers' resources—computers don't know which opinions are right, so they have to show people potentially all of them.

Discussion platforms have addressed this problem in several ways. The simplest way to address it is to filter content based on popularity (votes). This saves people from having to read a lot of content, since they can ignore the unpopular content. However, the content that's popular isn't necessarily good—it has just been judged by users to merit a “like.” This “like” could be earned because it is well reasoned and insightful, but it could also be earned by being cynically amusing, illogical but appealing to anger or bias, or for any other reason. Further, people who have a political agenda can take advantage of this by voting for content that supports their own side. In a system based on popularity, those people frequently outcompete people who are trying to share accurate information. This leads to an unstable environment where extreme views proliferate at the expense of moderate views.

Many discussion platforms attempt to deal with this problem by using moderators—people who have been given the authority to determine what's true. There are several problems with this. First, it's not very effective—moderators can only make decisions in special cases. Second, it's expensive in human resource time to moderate discussions on large platforms. Third, moderators introduce their own biases into their decisions. A discussion platform that depends on moderation is faced with the choice of how much moderation to do, with too little moderation permitting misinformation, and too much moderation resulting in the suppression of legitimate ideas. Both lead to loss of trust.

More recently, discussion platforms are attempting to address this problem using machine learning tools to automatically interpret the text of people's opinions. These have yet to prove effective, and they also suffer from the problem of lack of trust, since their algorithms are usually opaque. In addition, understanding natural language is resource-intensive and still fallible. It also still requires some other means to actually decide what's true.

All these approaches take for granted the framework for organizing content that has been in place for decades, the threaded discussion forum.

### SUMMARY OF THE EMBODIMENTS

This invention takes a different approach: Debaters encode the logical structure of their arguments in a framework designed so that these arguments can be processed by a computer. The system described here uses this structure to algorithmically identify logical contradictions and disputed points—places where one debater's views would make another debater's views obviously impossible. The disputed points are represented as short questions whose answers distinguish which debater is right. An end user is presented with these questions, and the user's answers are used to filter out debaters whose views are impossible. The key point is that the user doesn't need to actually read the debaters' arguments, but can find out which views are right just by answering the questions that have been presented.

The format in which debaters encode the structure of their arguments will be progressively developed herein. Section 1 describes the setting in which this process takes place—a collection of “simulated debates” between debaters. Sections 2 through 4 describe systems in which debaters enter instructions for how to engage in simulated debates with other debaters—that is, they must say explicitly how to identify places where their opponents' views are impossible. Sections 5 and 6 introduce more sophisticated formats for the structure of debaters' arguments (“constraints” and “tags”) that allow debaters to enter what they believe and what they think other people would believe, which the system can use to engage in simulated debates automatically. With the user's answers, the system essentially filters through the debaters' arguments and automatically determines whose views are right.

The system described here could be used in any situation where people are interested in rapidly finding answers to questions for which competing claims are being promoted, such as debates about political issues, scientific positions, or reviews of products or services. It could be used for debating issues directly—whether controversial claims are true or not—or it could be used as part of another platform to determine what content should be shown on the platform—whether a post is accurate or relevant, for example.

### BRIEF DESCRIPTION OF THE DRAWINGS

Further advantages of the invention will become apparent by reference to the detailed description of preferred embodiments when considered in conjunction with the drawings, which should be considered non-limiting:

FIG. 1 illustrates the states of a simulated debate.

FIGS. 2A-2D show several ways the system may be implemented on a network.

FIGS. 3A-3C show several graphical illustrations of logical structures.

FIG. 4 illustrates a simple attack plan.

FIG. 5 shows an attack plan constructed for an example.

### DETAILED DESCRIPTION OF THE EMBODIMENTS

Section 1: Debate-Based Discussion System

This section introduces the idea of a “debate-based discussion system” (DBDS). After introducing the basic ideas, this section will describe how a DBDS works, and will briefly touch on how it could be implemented. A DBDS is the setting in which the filtering process takes place that will be described in later sections.

How does one know which claim, among many competing claims, is right? The system described here solves this problem using simulated debates. In a simulated debate, users, called “debaters,” enter instructions that specify to a computer how to engage in debates with other debaters: what to ask your opponent in different circumstances, how to reply to your opponent's questions, etc. The system runs these debates and presents the outcomes to an end user called the “reader”, who is trying to determine who is right.

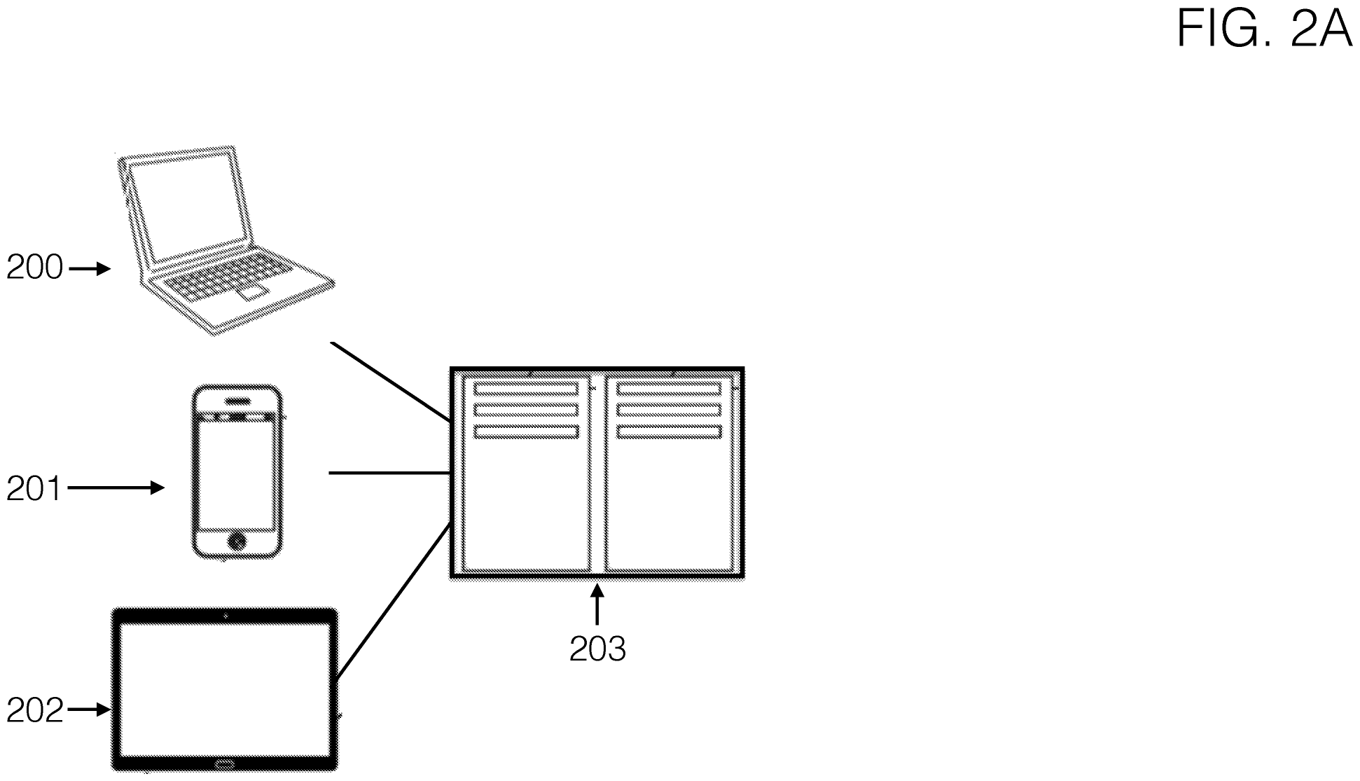

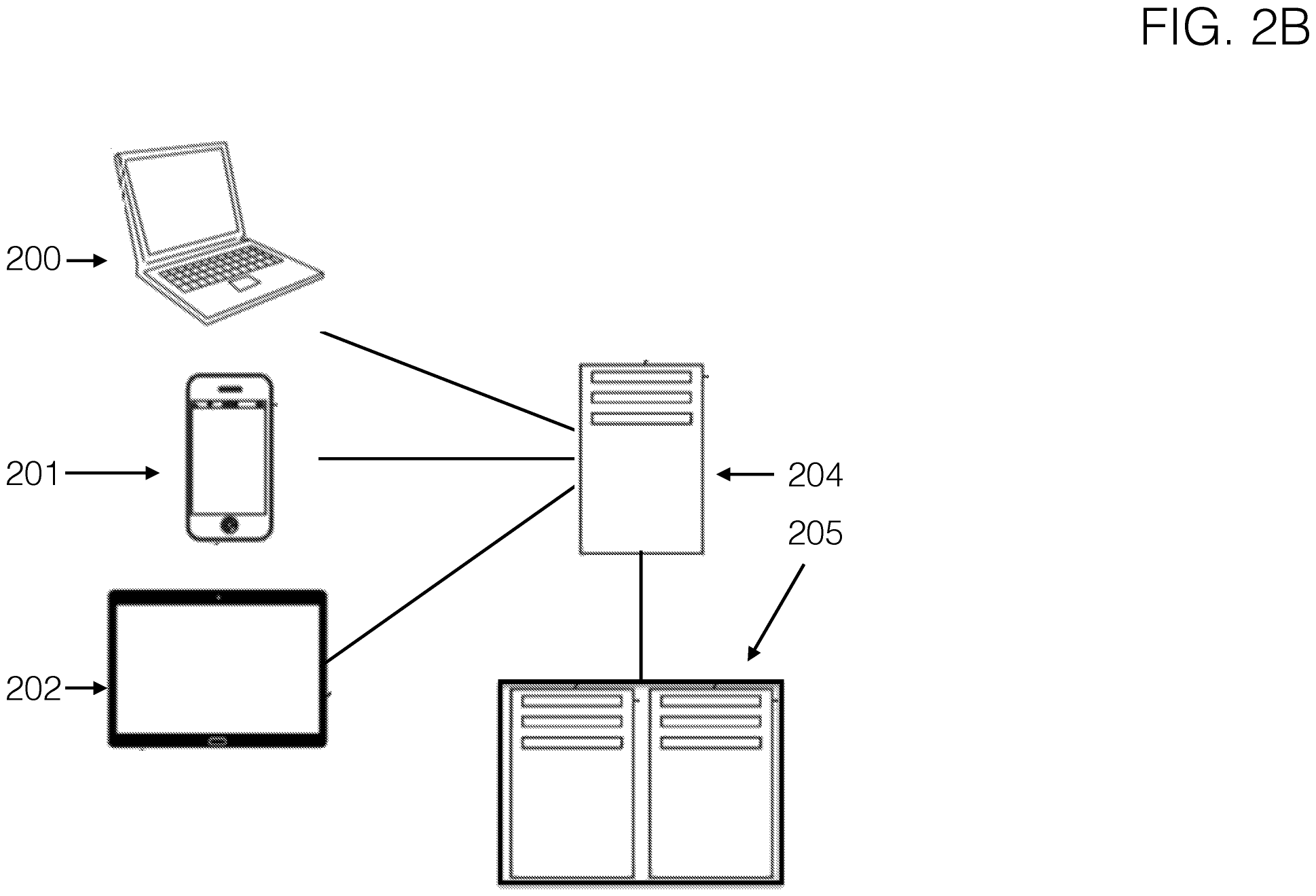

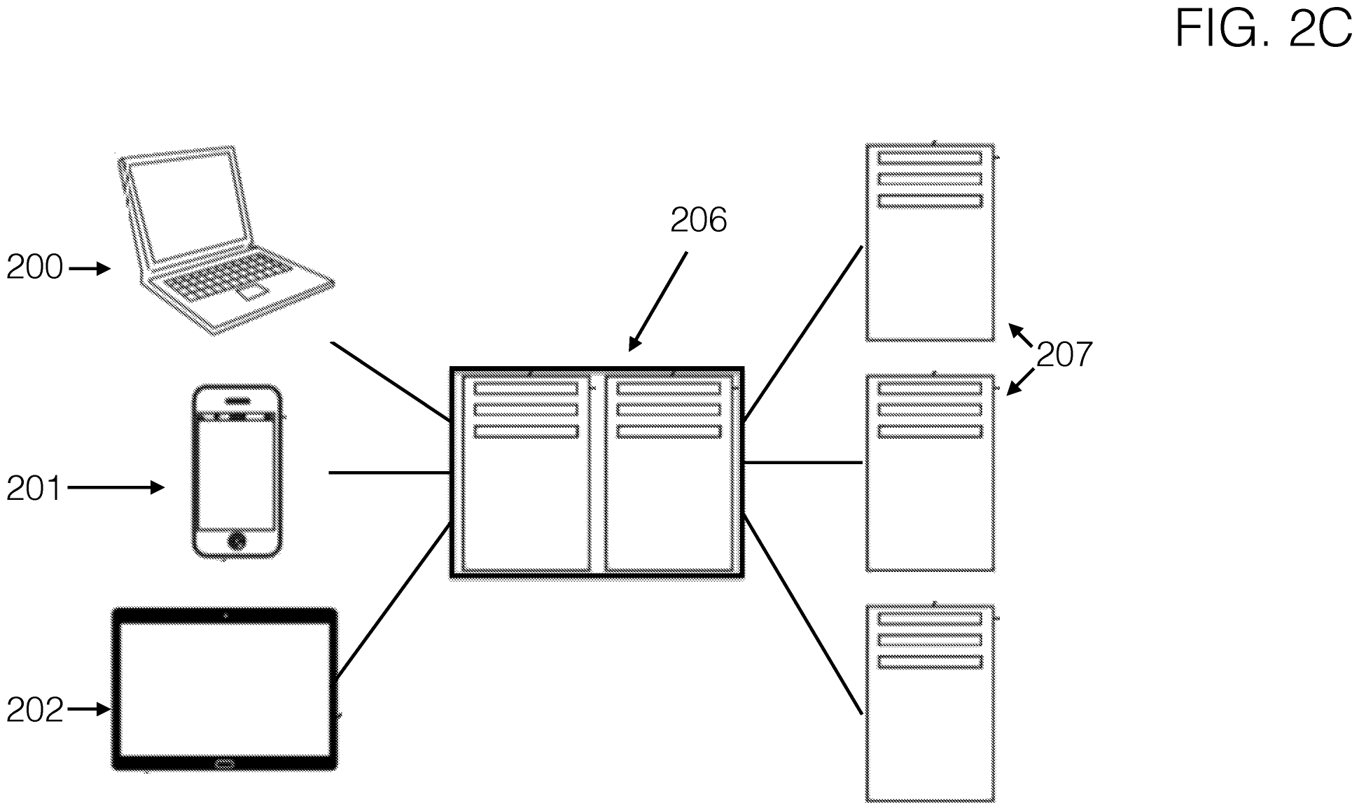

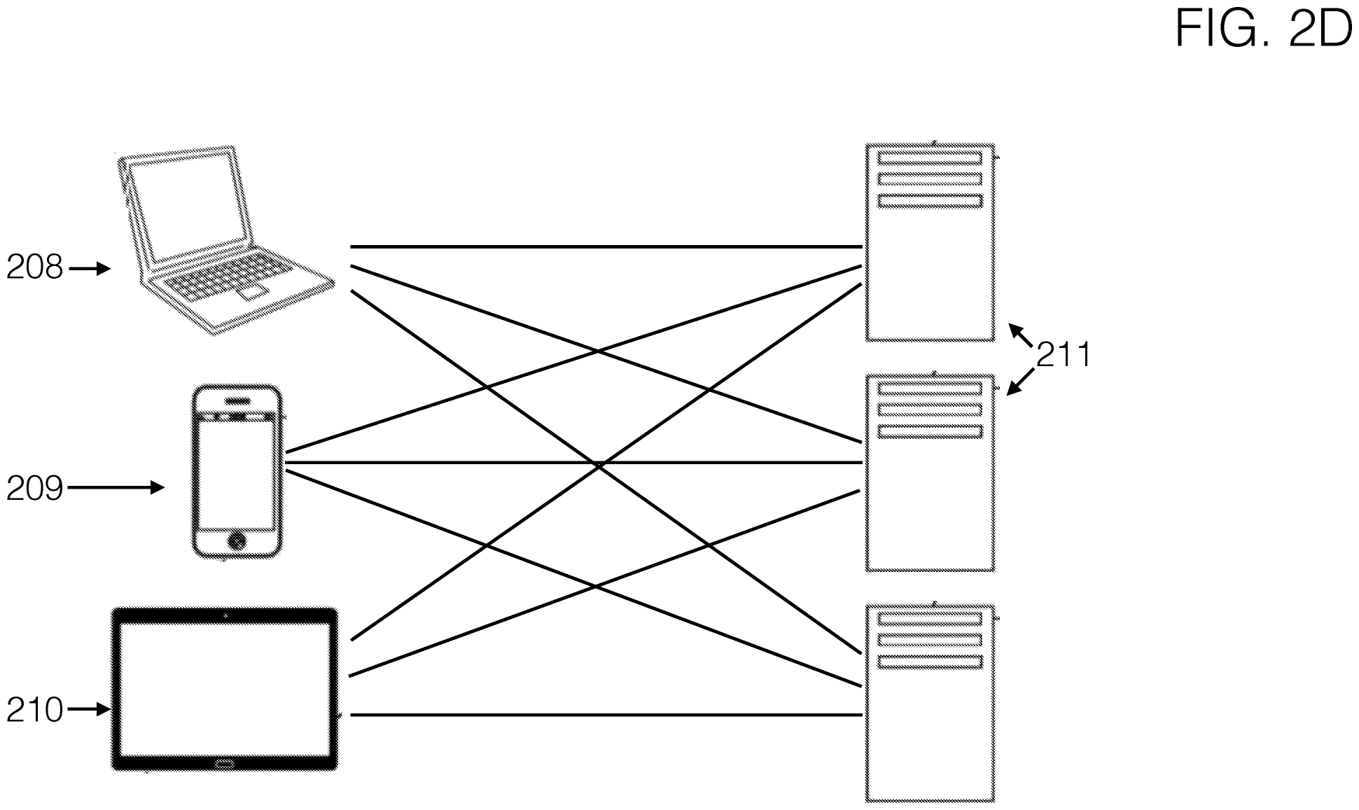

The purpose of a debate is to reduce something controversial to something obvious. If your opponent believes something you think is wrong, you can interrogate them, asking them about their beliefs, until you identify something in their beliefs that you think a neutral observer would find obviously wrong. For example, here is a debate between two debaters:
Debater 1: The economy is doing better this year.
Debater 2: No, it's doing worse.
Debater 1: Do you agree that the unemployment rate indicates how well the economy is doing?
Debater 2: Sure.
Debater 1: Do you agree that the unemployment rate is lower this year than last year?
Debater 2: No.
Debater 1: Do you agree that FIG. 2 on page 3 of the report found at the following link ( . . . ) is a plot of the unemployment rate, showing a decrease in the past year?
Debater 2: No.
Debater 1: I think you're obviously wrong about that.

Initially, debater 1 believes that debater 2 is wrong, but this wouldn't necessarily be obvious to readers who haven't yet made up their minds about this issue. However, by asking debater 2 questions about their beliefs, debater 1 has isolated something about debater 2's beliefs—that debater 2 refuses to accept something about the content found at a link—that debater 1 can show to readers, and readers can verify themselves (by clicking on the link). Debater 1 hopes that this will convince readers that debater 2's beliefs are wrong. The important thing is that readers can make this judgment just from debater 2's answer to that one question, rather than having to read through the entire debate. Having decided that debater 2's beliefs are wrong, a reader knows not to trust debater 2's opinion about this issue.

A “debate-based discussion system” (DBDS) is a system for running simulated debates between a large number of debaters, each of whom could potentially debate any of the others. Its main use is for someone to determine whether a controversial claim is true by seeing whether debaters who believe that claim end up surviving the debates.

The basic process in a DBDS is the “debate.” In a real-life debate, a debater promotes their own beliefs while simultaneously criticizing their opponent's beliefs. However, in this system, these two activities take place in separate debates, so that, in each debate, one debater is only promoting their own beliefs, while the other debater is only criticizing their opponent's beliefs. Specifically, in a DBDS debate, there are three roles:
1. The “defender” has beliefs that they assert are possible to consistently hold.
2. The “attacker” tries to defeat the defender by asking them questions about their beliefs, in order to identify something that the attacker thinks shows those beliefs to be impossible to hold.
3. The “observer” judges whether the defender's beliefs are in fact possible based on what the attacker has identified in them. “Debaters” refers to both attackers and defenders.

A debate involves the following actions:
1. The attacker can ask the defender a question about their beliefs.
2. The defender can answer the attacker's question by revealing something about their beliefs. When answering the attacker's questions, the defender can also voluntarily reveal some of their other beliefs.
3. The attacker can ask the observer a question based on what the defender has revealed about their beliefs.
4. The defender can amend the question to the observer by adding to it other things that they have revealed about their beliefs.
5. The observer's answer to the question determines who wins the debate, and thus indicates whether the defender's beliefs are possible to hold.

The attacker only has access to what the defender reveals about their beliefs. Likewise, the question to the observer can only involve what the defender has already revealed at the time it is asked. This restriction is important for what the defender adds to the question, in order to give the attacker a chance to debate about those beliefs before the question is asked.

The goal of a question to the observer (referred to simply as an “observer question”) is to present the observer with something about the defender's beliefs that the observer is equipped to judge—that the defender's beliefs include something obviously wrong, for instance, or that they include two things that obviously can't both be true. The outcome of the debate—whether the defender is defeated—depends on how the observer would actually answer the question. Sometimes the system needs to ask the observer the question in order to find out their answer. At other times, the system may be able to determine how the observer would answer the question from its knowledge of the observer's answers to questions from previous debates. In the example at the beginning of this section, the observer might have already verified the link when it was brought up in a previous debate. At still other times (to be discussed later), the answer to the observer question cannot be in doubt. In this case, the system doesn't actually need input from the observer to answer the question, but can instead simply point out to the observer the beliefs mentioned in the question.

A debate happens as follows. The defender chooses what part of their beliefs to reveal initially. In doing so, they are advertising their claim that it's possible to hold those beliefs, but at the same time exposing those beliefs to the scrutiny of other debaters. Based on the defender's initially revealed beliefs, the attacker decides whether to initiate a debate with them. The debate proceeds by the actions listed above, passing between the following five states, and ending up in one of them:
1. Waiting for defender: The attacker has asked the defender a question, but the defender hasn't answered yet.
2. Waiting for attacker: The defender has answered all questions, but the attacker hasn't yet taken further action.
3. Waiting for observer: The attacker has asked the observer a question, but the observer hasn't yet answered it, or answered other questions from which the answer to this question can be known.
4. Losing state for defender: The observer would judge the defender's revealed beliefs to be impossible, based on the observer's known answer to the asked question (known from the observer's answer to that question or to other questions).
5. Losing state for attacker: The observer would not judge the defender's revealed beliefs to be impossible, based on the observer's known answer to the asked question.

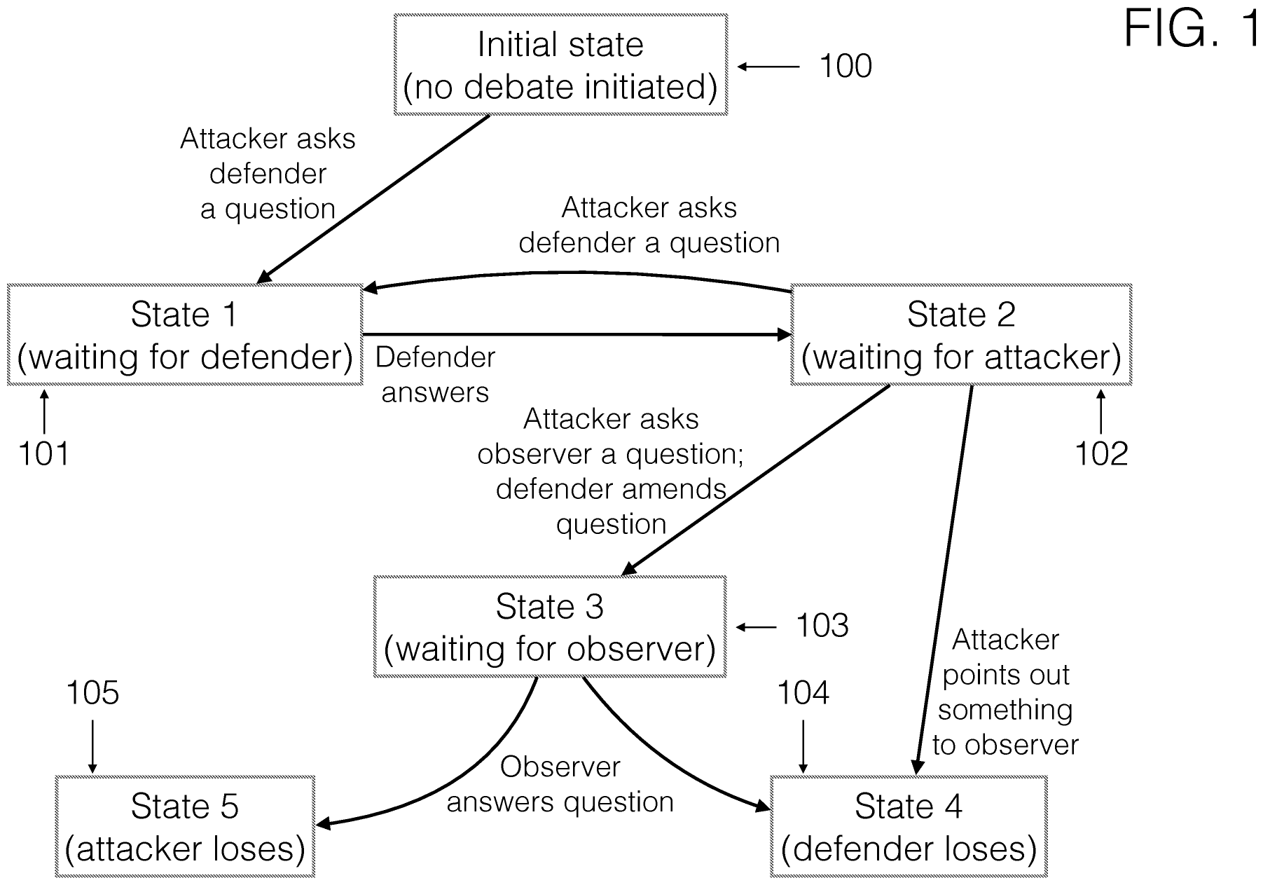

This is illustrated in FIG. 1, with boxes 100, 101, 102, 103, 104, 105 indicating the states (including the state before the debate begins) and arrows indicating actions that change the state. Neither debater wins until the debate enters state 4 or 5, but the debate might stop in a different state if the debaters or the observer hasn't provided enough information for it to continue.

In a simulated debate, all this takes place almost instantaneously in the computer, with the attacker's and defender's actions having been specified in advance by the users who are controlling them. The attacker's questions, and the beliefs that the defender reveals, are made available to both debaters, and are also stored, so that the debate can be evaluated once it has stopped. The debate can be run again (starting from the initially revealed beliefs) if the attacker specifies further actions to take, or if the defender adds to or corrects their beliefs. If the attacker's changes result in the system no longer initiating the debate, or cause the attacker to no longer take actions that were taken before, the attacker can be considered to have conceded to the defender. Likewise, if the defender's changes cause the system to no longer initiate the debate, the defender can be considered to have conceded.

Here's an example of a debate that may be simulated in a DBDS. For the moment, the means by which the debaters specify their actions isn't explained. (This will be explained starting in the next section.)
Defender initially reveals that they don't think that the economy is doing better in 2023 than in 2022.
Attacker initiates the debate by asking defender whether they think that the unemployment rate indicates how well the economy is doing. Debate enters state 1.
Defender reveals that they do think this. Debate enters state 2.
Attacker asks defender whether they think that a 2023 report showed that the unemployment rate decreased from 2022. Debate enters state 1.
Defender reveals that they do not think this. Debate enters state 2.
Attacker asks observer whether it's possible to not think that a 2023 report showed that the unemployment rate decreased from 2022, providing a link to the report. Debate enters state 3.
Observer looks up the report and answers that it's not possible. Debate enters state 4. Defender is defeated.

Having given the necessary background, this section will describe how a DBDS works. A DBDS has three types of users, (1) debaters, who promote their beliefs by participating as attackers and defenders in debates, (2) readers, who use debates to find information relevant to their interest, and, optionally, (3) observer predicters, who act as intermediaries between readers and debaters.

Debaters enter in the DBDS their instructions for how to engage in debates—what their beliefs are, which beliefs to initially reveal, how to decide when to initiate a debate with another debater, what to ask, how to respond to questions, and what to ask the observer. How they do this will be explained starting in the next section. They update this information whenever they want, perhaps as they become aware of new arguments or develop opinions about new topics.

Readers can use the DBDS in different ways. In one use, the system performs a search for debaters whose beliefs meet certain criteria. The search could be initiated by a reader, when the reader has heard a particular claim, perhaps elsewhere on the internet or in real life. The reader wishes to investigate whether the claim is true by searching for debaters who believe it (or who don't believe it), perhaps in combination with other claims. Alternatively, the DBDS could be part of another platform that uses the DBDS to judge content posted on it. In this case, debaters enter beliefs about whether particular content should be shown (whether someone's post is appropriate, relevant, should be banned, etc.), and the platform initiates a search on the DBDS to decide whether to show that content to one of its readers.

Given search criteria, the DBDS uses the following process to filter through all the debaters whose initially revealed beliefs satisfy the criteria. The system considers the beliefs of each debater in the system and determines which other debaters wish to initiate a debate with that debater based on the first debater's initially revealed beliefs. For each debater who wishes to initiate a debate, the system simulates a debate, with that debater as the attacker and the first debater as the defender. (Since debaters can specify both their own beliefs and how to debate other debaters' beliefs, a particular debater could be the attacker in some debates and the defender in other debates.) The debate proceeds automatically in the system, using the instructions that the debaters have already entered. As these debates progress, the observer questions produced in the debates are presented to the reader, who answers them based on their own beliefs. The record of the reader's answers to these questions is used to resolve debates that are in state 3, putting them into state 4 or 5 and eliminating attackers and defenders, using the rules described below. The presence of any remaining beliefs that satisfy the reader's search criteria indicate whether it's possible to hold beliefs that satisfy the criteria (and therefore whether the reader should believe the claim). This process makes that determination just from the reader's answers to the questions they are presented with, without the reader having to read the content of any of the debates.

Usually, the debates in which a debater is attacking are independent of the debates in which the debater is defending. However, in some implementations, they could be coupled, that is, the debate in which debater 1 attacks debater 2 would be linked to the debate in which debater 2 attacks debater 1. The system would impose a rule that neither debate can be resolved (enter state 4 or 5) until each debater has had a chance to initiate a debate against the other debater, and both debates, if initiated, have finished. Furthermore, a debater is considered to have lost the debate in which that debater is the attacker (the debate goes into state 5) unless that debater not only defeats the defender in that debate, but also avoids being defeated in the debate in which their roles are reversed.

When there are a large number of debaters, many of them might be asking each other questions that are irrelevant, either because they are uninformed or to deliberately waste their opponents' time. The system therefore needs a way to decide which debaters are obligated to answer their opponents' questions. Since any question, even if it sounds bizarre, might be part of a legitimate argument, the system can only make this determination based on debaters' success against other debaters.

Here are rules for determining which attackers and defenders to eliminate that are designed to take this into account: A defender should be eliminated whose beliefs have been judged impossible, that is, who leaves any debate in state 4 (perhaps for longer than some time limit). And an attacker should be eliminated whose questions fail, that is, who leaves any debate in state 5 (perhaps for longer than some time limit). A defender should also be eliminated based on debates in state 1 with attackers who themselves are not being eliminated: if there are more than some limit of unanswered requests for a single question, or if the debate has been in state 1 for longer than some time limit. An attacker should be eliminated if that attacker has asked more than some limit of questions in a single debate, or if a debate with a noneliminated defender has been in state 2 for longer than some time limit. Other measures besides these might also be relevant. The rules are different for states 1 and 2 than for states 4 and 5 because contradicting the observer always eliminates a debater, but not responding to another debater only eliminates the debater if the other debater doesn't end up being eliminated.

The limit on a defender of the number of requests for a single question motivates attackers to ask the same questions as each other, rather than each using their own equivalent version of a question, which might be too much work for the defender to answer.

In addition to these reasons for eliminating debaters, the reader might want to eliminate individual debaters by hand, or to eliminate debaters based on criteria such as having conceded a debate within a given number of days. Perhaps the reader might impose harsher penalties on defenders whose beliefs are impossible in a way that's particularly obvious, or whose defeat required more of the attacker's efforts that did not also go towards defeating other defenders.

Note that one reader's actions don't affect what other readers see—each reader judges for himself or herself. This removes the motivation for readers to answer questions just because they want to promote their own beliefs, and frees readers to answer in accord with what they actually think is true in order to find out whose views are correct.

Since the conditions for debates in states 1 and 2 depend on which other debaters are to be eliminated, the system needs to solve the conditions for all debaters simultaneously in order to calculate a consistent set of debaters to eliminate. There are many possible variations for how this could be done. One way the system could do this is by initially assuming all defenders should be eliminated, then iteratively reinstating defenders who don't meet the conditions for being eliminated based on remaining attackers, while eliminating attackers who meet the conditions for being eliminated based on reinstated defenders. Alternatively, the procedure could swap the roles of attacker and defender, initially assuming all attackers should be eliminated and reinstating them while eliminating defenders.

After elimination, the system displays to the reader the observer questions from all debates that remain in state 3, in a list prioritized by how many debates each question would settle between remaining attackers and defenders. It could also list the remaining defenders, in a list prioritized by the maximum number of requests for a single unanswered question, by the maximum time that any debate has been in state 1, again only in debates with attackers who weren't eliminated, or by another relevant measure of reliability. The reader could answer any of the listed questions, which would settle those debates, causing the elimination procedure to be run again and the display to be updated. The reader could also examine the beliefs of any of the listed defenders. To illustrate, this is the kind of display that the reader might see Tables 1 and 2:

TABLE 1

| Observer questions | Number of state 3 debates |
|---|---|
| Is it possible to have beliefs that: | your answer would settle |
| accept . . . ? | 456 |
| don't accept . . . ? | 321 |
| accept . . . yet don't accept . . . ? | 123 |

TABLE 2

| | Maximum requests for a | Maximum time in | |
|---|---|---|---|
| Remaining defenders | single unanswered question | state 1 | |
| Debater 101 | 1 | 30 | minutes |
| Debater 203 | 2 | 2 | hours |
| Debater 406 | 2 | 19 | hours |

| | | |
|---|---|---|
| Debater 1080 | 5 | 1 day 3 hours |
| . . . | . . . | . . . |

In this way, the reader eliminates large numbers of debaters by answering short, simple questions, without having to read what any of these debaters are saying.

In some implementations, while simulating debates with the reader's search criteria, the system also simulates a separate set of debates with no search criteria (that is, any beliefs qualify). This separate set of debates happens at the same time as the main debates. If, at the end of this separate set of debates, no defenders remain, this informs the reader that the beliefs the reader is ascribing to the observer are themselves inconsistent, so that the reader can go back and revisit the answers they gave in the main debates.

Alternatively, in other implementations, the system simulates a separate set of debates in which any debater who wished could attack the observer's beliefs. The reader takes the role of the defender in these debates, answering the questions that would normally be directed to defenders, but in these debates are about the observer. These questions could be displayed separately or could be interleaved with the observer questions from the main debates. If the reader is defeated, it informs them that they are ascribing inconsistent beliefs to the observer, so that they can correct their answers in the main debates. Questions from defenders who have been defeated in the main debates could be given priority in these separate debates, to give those defenders a chance to avoid being defeated due to the reader's mistake.

By just answering observer questions instead of having to read through debates line by line, the burden on readers is lower. In some implementations of a DBDS, this burden may be lowered even further with an additional type of user, an “observer predicter,” to act as an intermediary between readers and debaters. Observer predicters attempt to predict the reader's answers to observer questions. Their predictions could be used to help prioritize questions shown to the reader that may likely defeat a lot of defenders, or even to answer questions on the reader's behalf and eliminate debaters (subject to being overridden by the reader). This would prevent readers from having to answer questions from all the debates being simulated by the system, instead leaving to the observer predicters' judgment which questions to answer. Of course, to be useful, their predictions have to match how the reader would answer, so the system needs a mechanism for deciding which observer predicters to use for each reader. The reader's actual answers would determine the reliability attributed to each observer predicter. Perhaps observer predicters could be rewarded for providing predictions on questions that not many other observer predicters have answered, to lessen the need for observer predicters to address everything. To make this determination more efficient, the system could recommend to the reader questions that provide the most information about observer predicters' reliability, even if they don't directly address the current debate.

The system could include functionality to help debaters efficiently update their instructions for engaging in debates. In particular, attackers might need help deciding what questions to ask. Since defenders are judged by the maximum number of requests for a single question, to help an attacker, the system could find all debates with defenders who are waiting for that attacker to take further action (that is, the debate is in state 2), and suggest the questions that other attackers most commonly ask these defenders. This may be useful to help drive up the maximum number of requests for a single question for the attacker's opponents. Similarly, defenders might need help deciding what questions to provide answers for. For this, the system could list attackers' most asked questions that the defender hasn't answered yet (which therefore leave debates in state 1). The system may also have functions to show how a debate between two particular debaters proceeds.

In another use of a DBDS, readers engage in debates themselves, as an attacker attacking a particular defender or as a defender defending against a particular attacker, using the same rules that govern simulated debates. Defending against an attacker involves answering the attacker's questions and reading the observer question at the end. In this process, the reader would hold two sets of beliefs in mind, the beliefs the reader is entertaining for the purpose of this debate, and the beliefs of a hypothetical observer whose scrutiny the reader wants to make sure those beliefs stand up to. Attacking a defender involves looking through that defender's beliefs and eventually formulating a question to the observer, allowing the defender to add to the question beliefs that might change the reader's answer. The system could allow the reader to attack many defenders or defend against many attackers at the same time, sorting questions by how many opponents are asking or answering them and letting the reader choose which to ask or answer. It could be done against all the debaters on the system, or just against the ones who were not eliminated in previous simulated debates, to test those surviving debaters against the reader's own arguments. This use of a DBDS allows it to function as an attacker and/or a defender in a real debate, either played off against someone else with the reader being the observer, or to assist the reader in figuring out what to do in a debate against a real-life opponent, or an opponent on social media.

The rest of this section will briefly discuss the implementation of a DBDS (or any of the systems described in the other sections) on a network and in hardware. One implementation of a DBDS may be as a standalone discussion site, on which debaters debate issues directly. A reader may use the site when they are interested in investigating a particular claim, in order to judge whether it's possible to consistently believe (or disbelieve) the claim. Debaters who support or oppose the claim also go to the site and enter their beliefs, along with their instructions for engaging in debates with their opponents. FIG. 2A illustrates this implementation. Readers and debaters use their own client devices 200, 201, 202, which may be local machines, personal computers, mobile devices, or tablets, to connect to the server 203 that runs the DBDS. This may be a single server, or it may include multiple servers stored in high-density rack systems.

An alternative implementation of a DBDS may be as a service for other web sites, such as online newspapers or blogs, or other discussion forums. In this implementation, illustrated in FIG. 2B, a web site that needs a way to filter its content uses a DBDS for this purpose. The site's users, which include both debaters who wish to participate in debates and readers who wish to use the results, use their own devices 200, 201, 202 to connect to the site 204. The DBDS could be integrated into the site's software, or the site could connect to a separate server or servers 205 that runs the DBDS. This server 205 runs the simulated debates, obtaining the necessary information from and communicating results to the site 204, which in turn communicates with the client devices.

There are also several possibilities for how the data and processing of a DBDS can be distributed over a network. In one possibility, shown in FIG. 2A, a central server 203 stores all debaters' beliefs and their instructions for engaging in debates, as well as storing all readers' answers to observer questions, for both present and previous debates. This server runs and referees all the simulated debates between debaters, and, as part of this, determines the actions that each debater takes in each debate (the specifics of which will be described in later sections). Debaters and readers access the DBDS by connecting to the server using their client devices 200, 201, 202, which do not need to store any data or perform any significant processing.

FIG. 2C shows another possibility. Here, a central server 206 runs all the simulated debates and stores all the information associated with each reader. However, the activity of debaters is delegated to separate servers 207, which debaters set up themselves. Each server could host one debater, or it could host many debaters, perhaps being set up for the benefit of debaters with particular political views. The important difference is that these servers store debaters' information (their beliefs and instructions for engaging in debates with other debaters), and are responsible for determining the actions that debaters take during a debate. The central server 206 sends requests (for a defender to answer a particular question, for an attacker to perform another action, etc.) to a debater's server 207, which responds appropriately. This arrangement may greatly reduce the amount of processing required on the central server. If a debater wanted to act in a particularly complicated way in a debate, that debater would have the responsibility for providing the hardware necessary to do it.

FIG. 2D shows a third possibility. Here, there is no central server. Instead, each reader has a client device 208, 209, 210 that runs simulated debates and stores that reader's answers to observer questions. Each client communicates directly with all of the debaters' servers 211, requesting what actions the debater wishes to take in a debate, receiving those actions, and determining the outcome of the debate. This arrangement distributes the computational work of running debates among the readers. Readers' clients may have to be provided with a list of active debaters' servers, which could be maintained with minimal effort on a central site or on many independent sites. Readers would be free to ignore debaters who were not reliable in the past.

For any of these possibilities, the network over which debaters and readers connect to each other and to servers could be a public network, like the internet, or it could be a private network such as an organization's intranet. A DBDS run on a private network could be useful for hosting debates within a company, for example to give teams a rigorous way to choose between competing ideas. The network may be wired or wireless. A client may access servers through a web interface, or they may download a DBDS application and install it on their device.

The clients and servers may be embodied in a computer, network device or appliance capable of communicating with a network and performing the actions herein. The computer system may be any workstation, desktop computer, laptop or notebook computer, netbook, tablet, server, handheld computer, mobile telephone, smartphone or other portable telecommunications device, mobile computing device, or any other type and/or form of computing, telecommunications or media device that is capable of communication. The CPU may use instruction level parallelism, thread level parallelism, different levels of cache, and multi-core processors. The system may perform its functions through software, programmed hardware, or other computing means. Since each debate is essentially run independently of the others, and debaters don't need to communicate with each other except through the actions of a debate, a CPU that is capable of running multiple debates on separate cores or in separate processors simultaneously might be beneficial. Servers might even use dedicated hardware designed for efficiently performing the logical operations that will be described in later sections (the equivalent of a graphics processing unit for logic).

Section 2

Section 1 introduced the idea of a “debate-based discussion system” (DBDS), but left unspecified how debaters' beliefs are represented, the kind of questions debaters can ask each other about their beliefs, and how beliefs are presented to the observer. Section 2 describes a “worldview-based discussion system” (WBDS), a DBDS in which debaters' beliefs are represented in a specific way, called a “worldview.” The remaining sections are all modifications or additions to a WBDS.

The present section introduces worldviews and gives the rules for how debates work with worldviews—what questions debaters ask each other and what they present to the observer. It also describes a way for debaters to enter their instructions for engaging in debates.

People usually explain their beliefs using statements that they think are true. When asked about those statements, they back them up with reasons, other statements that they believe argue those statements. In theory, every statement is argued from other statements, continuing infinitely far back (or perhaps to some foundational beliefs). However, in practice, this would be impossible. Because of this practical impossibility, in a discussion system, a debater must be content with specifying their beliefs only back to a point, and at that point to stop giving further reasons for their beliefs. The framework described in this section is a simple way of representing people's beliefs that accounts for this.

In this system, a defender's beliefs are expressed in statements. In general, statements are facts about the world, but they might also depend on arbitrary choices about how words are used. Accepting a statement means claiming that it's true. Not accepting it means not claiming that it's true, but not necessarily claiming that it's false, for example, if you don't know whether it's true.

A defender's beliefs are described by a “worldview,” a set of positions (“accept” or “not accept”) taken on various statements, along with reasons for accepting the statements that are accepted. A reason for a statement is a set of other accepted statements that are claimed to imply the first statement. In what will be called a “theoretical worldview”, every accepted statement is argued from other accepted statements, continuing infinitely far back.

In the worldview that the defender specifies on the system, which will be referred to simply as the debater's “worldview”, the debater stops giving reasons for statements at some point. In a WBDS, a worldview is:
1. for some statements, the defender's position on that statement (“accept” or “not accept”)
2. for some statements that are accepted, a reason for that statement, which is a set of other statements, all of which must also be accepted

Statements with a reason are called “supported.” Accepted statements without a reason are called “assumed.” Even though not accepting a statement doesn't mean claiming that it's false, it does prevent the debater from using it as a reason for something else.

The system may impose a limit that the length of a chain of reasons can't exceed. Also, since arguments theoretically continue infinitely far back, a chain of reasons can't return to the same statement (circular reasoning). The system can check for these things and cause the defender to be defeated if they occur.

When defenders' beliefs are represented as worldviews, it makes the rules governing debates that were described in Section 1 more specific. They will be described in the paragraphs that follow.

An attacker can ask a defender two types of questions:
1. A “whether” question: whether the defender accepts a particular statement (the defender's position on it)
2. A “why” question: for a statement that the defender has revealed to be accepted, why the defender accepts it (what the defender's reason is)

The defender can answer the first question with yes or no. The defender can answer the second question in one of two ways, (1) by giving a reason, that is, by giving a list of other statements, which are thereby revealed to be accepted, or (2) by answering that the defender doesn't have a reason and so is simply assuming the statement. The defender can voluntarily reveal positions and reasons for other statements as well.

The attacker can ask the observer a question of the form “Is it possible to have a worldview that . . . ,” followed by a list of one or more conditions, separated by “and,” that could apply to a worldview, for example, “Is it possible to have a worldview that doesn't accept statement 2, doesn't accept statement 3, and assumes statement 1?” The conditions can be about positions (accepting or not accepting a statement) or about reasons (accepting a statement for a particular reason, or assuming it). Specifically, each condition can be one of the following:
1. accepts statement . . .
2. doesn't accept statement . . .
3. accepts statement . . . and gives as a reason statements . . .
4. assumes statement . . .
   The defender can amend the question with additional conditions. The phrasing of the question could vary between implementations, as long as it conveys the idea that the question is about whether a worldview can meet all of the conditions simultaneously. The order of the conditions shouldn't matter. The system will probably need to impose practical limits on the number of conditions that the attacker can include in the question, and the number of conditions that the defender can add to it.

The observer's answer can be either yes or no. The system concludes from the observer's answer whether the observer thinks that it's possible for someone to consistently hold such a worldview. In that example, if the observer answers no, the system would know that the observer thinks it's impossible to have a worldview that assumes statement 1, doesn't accept statement 2, and doesn't accept statement 3.

In some implementations, the defender's amendments are incorporated directly into the observer question. In other implementations, in order for the system to obtain more specific information about the observer's beliefs from the observer's answer, when the defender amends a question, the additions are instead first asked of the observer individually. For example, if the attacker asks the observer, “Is it possible for a worldview to not accept statement 4?,” and the defender amends the question by adding that they don't accept statements 5 or 6, the observer is first asked, “Is it possible for a worldview to not accept statement 5?” and “Is it possible for a worldview to not accept statement 6?” If the observer answers no to any of these questions, it would result in the defender's defeat. However, because each question is about not accepting a single statement, the system is able to infer the observer's beliefs about that statement specifically (which might help the defender to argue against it). If instead the observer answers yes to all the added questions, the original question is then asked, but it is modified to include a reminder to the observer that they answered yes to the added questions. In this example, if the observer answered yes to the questions about statement 5 and statement 6, the observer would then be asked, “Remembering that you said it is possible to not accept statements 5 and 6, is it possible for a worldview to not accept statement 4?” For an observer question with more than one condition, the defender can “amend” the question with statements that are already in the question, if the defender wants those statements to be asked separately first.

The outcome of a debate—whether the observer would judge the defender's worldview to be impossible—is determined by the system's knowledge of how the observer would answer the observer question—the observer's beliefs about the worldview given in the question. As mentioned earlier, this knowledge can be obtained from the observer's answer to that question or from the observer's answers to previous questions. There are two types of observer questions that can be asked, each of which determines the outcome of a debate in a different way.

In the first type of observer question, the worldview given in the observer question is a subset of the defender's worldview (in other words, all of its conditions are true about the defender's worldview). In that case, if the observer would answer that the given worldview is impossible, then the observer would judge the defender's worldview to be impossible, causing the debate to go into state 4. If the observer would answer that the given worldview is possible, then the observer would not judge the defender's worldview to be impossible, putting the debate into state 5. In the previous example, if the observer answers no, a defender who assumes statement 1, doesn't accept statement 2, and doesn't accept statement 3 would be defeated.

In the second type of observer question, the worldview given in the observer question, rather than being a subset of the defender's worldview, could be a statement that the defender accepts and the statements in the reason for it, with the first statement listed as not accepted (listed as “doesn't accept statement . . . ”) instead of accepted. The question can also include other conditions about the defender's worldview that the attacker (but not the defender) wishes to add. In this case, the system takes the observer's judgment about the defender's worldview to be the opposite of the observer's answer to the question, so, for example, if the observer would answer that the given worldview is possible, then they would judge the defender's worldview to be impossible. This provides a way for an attacker to ask the observer whether one of the defender's reasons is good enough, the idea being that a reason is good enough if it's impossible to deny the consequences of it. For example, if the observer answers yes to “Is it possible to have a worldview that accepts statements 7 and 8 and doesn't accept statement 9,” a defender who gives statements 7 and 8 as the reason for accepting statement 9 would be defeated. This eliminates the need for observer questions to mention reasons. Instead, they only need to contain the following conditions: “accepts statement . . . ,” “doesn't accept statement . . . ,” “supports statement . . . ,” and “assumes statement . . . .” Conveniently, all of these are about single statements.

In some implementations, as the system simulates debates, it also simulates a separate set of debates in which debaters can attack the observer's requirements—that is, the “worldview” made up of the statements that the reader, answering as the observer, believes are impossible for a defender's worldview to not accept. The system can infer what statements are in this “observer's requirements worldview” from the reader's answers to observer questions. If the reader answers no to a question about whether it's possible to not accept a statement, then that statement is part of this “worldview”. As mentioned in Section 1, defeating the observer in these separate debates informs the reader that they are incorrectly requiring something when they answer observer questions, so they can go back and revisit those answers.

A debate against the observer's requirements worldview works a little differently than a normal debate against another debater. When the reader is asked a question that would normally be directed to a defender, if the question would normally be about whether a statement is accepted, the reader is instead asked whether it's possible to not accept it (that is, whether the observer requires it). If the question would normally be about why a statement is accepted, it isn't asked at all, and the reader's answer is taken to be that the statement is assumed. (Since everyone knows their own arguments, the “requirements worldview” doesn't need to have any reasons.) Questions that would normally be directed to the observer are also directed to the reader, as usual, but they are handled differently. It is assumed that the reader would be consistent in their answers, so a question about a single statement, which the reader would have already been asked as a defender, shouldn't be asked again. Rather, the previous answer is taken to be definitive. But for an observer question with multiple statements, it's possible that the reader hasn't considered that combination of statements together, so the question should be asked. Since the question is about the observer's requirements rather than about whether a worldview is possible, each condition that would normally be phrased as “accepts . . . ” or “assumes . . . ” is instead phrased as “not possible to not accept . . . ” (that is, can it be in the observer's requirements), and each statement that would normally be phrased as “doesn't accept . . . ” is instead phrased as “possible to not accept . . . ” (that is, can it be absent from the observer's requirements). So, for example, rather than being asked “Is it possible to have a worldview that doesn't accept statement 10 and assumes statement 11,” the reader is asked, “Is it possible to not accept statement 10 and not possible to not accept statement 11,” that is, can statement 11 really be in the observer's requirements worldview if statement 10 isn't? Since the reader would have already given answers about the statements individually, the question can even be phrased as, “Is it really possible to . . . ?,” reminding the reader that they previously said all of those things. In this type of debate, there doesn't need to be an option for the reader to volunteer anything that wasn't asked or to add anything to an observer question, as it would be unnecessary for readers to inform themselves about their own arguments. If the system finds that the reader answers inconsistently (answering a question about the same statement in two different ways), the system can inform the reader, so the reader can revisit their previous answers.

As an example of a very simple debate in a WBDS, suppose that the following statements have been defined:
1. The economy is doing better in 2023 than in 2022.
2. The unemployment rate indicates how well the economy is doing.
3. A 2023 report showed a decrease in the unemployment rate from 2022.

And suppose that the defender has a worldview that doesn't accept statement 1 and accepts statements 2 and 3 (without giving a reason for them). A debate might proceed as follows:
Defender initially reveals that defender doesn't accept statement 1.
Attacker asks defender whether defender accepts statement 2. Debate enters state 1.
Defender reveals that defender accepts statement 2. Debate enters state 2.
Attacker asks defender whether defender accepts statement 3. Debate enters state 1.
Defender reveals that defender accepts statement 3. Debate enters state 2.
Attacker asks observer whether it's possible to have a worldview that accepts statement 2, accepts statement 3, and doesn't accept statement 1. Debate enters state 3.
Observer answers no. Debate enters state 4. Defender is defeated.

For a WBDS to know how to simulate a debate, the debaters must specify how to engage in debates with each other—what actions to take under what circumstances. The rest of this section will describe a simple way for debaters to specify this. They enter the following information (although the precise way they encode the information depends on how the system is implemented):

An attacker specifies a list of “attacks,” each comprising (1) a list of one or more conditions and (2) an action that is triggered if the defender's worldview, as revealed in the debate so far, meets all the conditions. By specifying an attack, the attacker claims that, if a defender's worldview meets the conditions, the attacker will be able to defeat the defender, and that taking the associated action is the next step in defeating him. A condition can be any one of the following:
1. that the defender accepts a particular statement
2. that the defender does not accept a particular statement
3. that the defender assumes a particular statement
4. that the defender accepts a particular statement and gives a (nonempty) subset of a given list of other statements as the reason

The action can be asking the defender a question about the defender's worldview (a “whether” or “why” question, as discussed above) or asking the observer a question. If the implementation only allows observer questions that are a subset of the defender's worldview (the first type of observer question), each condition of the observer question would be one of the following:
1. accepts a particular statement
2. doesn't accept a particular statement
3. assumes a particular statement
4. accepts a particular statement and gives as a reason a list of other statements

If the implementation also allows observer questions about whether a reason is good enough (the second type of observer question), observer questions don't need to mention reasons (as discussed above), so the conditions that can appear in them only need to be:
1. accepts a particular statement
2. doesn't accept a particular statement
3. assumes a particular statement
4. supports a particular statement

In implementations in which debaters can attack the observer's requirements, attackers could either specify a separate set of attacks that applied to the observer's requirements instead of to defenders' worldviews, or they could specify a single set of attacks, but designate each attack as applying to defenders, to the observer, or to both.

Besides being specified by the attacker, attacks could also be automatically generated from the system's knowledge of the observer's requirements. For example, if the observer has answered no to “Is it possible for a worldview to not accept statement 1?,” the system would add an attack whose condition is that the defender doesn't accept statement 1, and whose action is to ask the observer whether this is possible, thereby automatically allowing this attacker to defeat defenders who have revealed that they don't accept statement 1.

Any action taken by the attacker initiates the debate if it hasn't already been initiated.

A defender specifies, for each statement in the defender's worldview:
1. whether the defender accepts it or not
2. whether the defender wishes to reveal their position on it initially, or only when asked
3. if the defender accepts it and wishes to give a reason for it, a list of one or more other accepted statements that make up the reason; otherwise, the defender assumes it
4. optionally, a list of zero or more extra statements to also reveal the defender's position on, or reason for, when asked about this statement

In simulated debates, the defender only answers questions about statements that are in their worldview. Other questions are left unanswered. In some implementations, the system could allow the defender to specify that a statement is accepted (which the defender would answer when asked) without specifying whether there is a reason for it or not (which the defender therefore wouldn't answer).

In addition to a worldview, a defender can specify, for some questions that the attacker may ask the observer, a “defense”, comprising:
1. an observer question the attacker may ask
2. a list of other positions and reasons to amend the question with

The observer question is specified in the same way as it is for an attack's action. The defense applies to any question the attacker asks that's a superset of that question.

Since the defender is only allowed to amend the question with statements that has already been revealed during the debate, the system could optionally, when answering the attacker's questions, use the defender's defenses to automatically reveal anything that the defender may need to amend any question that could be asked in the debate's current stage. This would eliminate the need for defenders to explicitly list extra statements to reveal.

An observer predicter specifies a list of predictions, each comprising:
1. an observer question
2. the observer's predicted answer (yes or no)

When debaters are formulating their attacks and defenses, the system can provide them with information about what their opponents are doing, in order to help them decide how to respond as efficiently as possible. In order to help the attacker decide what attacks to specify, for each attack the attacker has entered, the system should display how many defenders the attack's conditions apply to. For attacks without an action specified yet, display the most common questions that other attackers would ask for the attack's conditions (that is, what other attackers would ask next if debating a worldview containing the attack's conditions). For attacks whose action is a question to the defender, display the most common ways that the attacker's opponents answer it, and, if the attacker has a follow-up attack for that answer (an attack against a worldview containing the conditions of the question with that answer), which attack that is. For attacks whose action is a question to the observer, display the most common ways that opponents amend it. To help a defender decide what statements to add to the defender's worldview, the system should display the statements that the defender's opponents are most commonly asking the defender about that the defender hasn't answered yet, along with the most common answers that other defenders would give. To help a defender decide what defenses to specify, the system should display the questions that the defender's opponents are most commonly asking the observer, along with the most common ways that other defenders would amend that question. If an attacker has an attack with no action, or takes no action for a common answer to a question, alert that attacker that there may be debates left in state 2. If a defender has no answer for a question, alert that defender that there may be debates left in state 1.

The rest of this section will illustrate how a WBDS could be used to debate an issue. Suppose a group of debaters have different opinions about a particular issue—whether swearing is OK. One of them who thinks that it's impossible to accept the statement “You shouldn't be allowed to swear,” who will be referred to as debater 1, enters the following statements in the system:
1. You shouldn't be allowed to swear.
2. You shouldn't be allowed to say things that are offensive.
3. You shouldn't be allowed to insult people.
   They specify the following attacks in the format described above as shown in Table 3:

TABLE 3

| Conditions | Action |
|---|---|
| accepts 1, doesn't accept 3 | Ask defender whether accepts 2 |
| accepts 1, doesn't accept 2 | Ask defender why accepts 1 |
| assumes 1, doesn't accept 2 | Ask observer whether it's possible to have |
| | a worldview that assumes 1 and doesn't |
| | accept 2 |
| accepts 2, doesn't accept 3 | Ask observer whether it's possible to have |
| | a worldview that accepts 2 and doesn't |
| | accept 3 |

They hope to defeat all the debaters who do accept statement 1.

A debater who thinks that it is possible to accept statement 1, debater 2, enters an additional statement in the system:
4. Insulting people is offensive.
   They specify the following worldview in the format described above as shown in Table 4:

TABLE 4

| Statement | Accept? | Reveal? | Reason | Also reveal |
|---|---|---|---|---|
| 1 | Yes | Yes | 2 | |
| 2 | Yes | no | assumed | 4 |
| 3 | no | Yes | | |
| 4 | no | no | | |

They additionally specify a defense in the format described above as shown in Table 5:

TABLE 5

| Observer Question | Amendments |
|---|---|
| Is it possible to have a worldview that | 4 |
| accepts 2 and doesn't accept 3? | |

They hope that this worldview can survive all attacks from other debaters.

A reader is curious about whether it's possible to accept the statement “You shouldn't be allowed to swear,” so they perform a search for all worldviews that accept statement 1. Since debater 2's worldview, based on what it initially reveals, satisfies that criterion, it will be shown to the reader at the end of the debate if it isn't eliminated. The system applies the rules described in this section to decide whether to initiate a debate between each pair of debaters. Since debater 1's first attack applies to the initially revealed part of debater 2's worldview, the system initiates a debate in which debater 1, the attacker, is attacking debater 2, the defender. Using the rules described in this section, the system simulates this debate. It proceeds automatically from what the two users have specified:
Defender initially reveals that defender accepts statement 1 and doesn't accept statement 3.
Attacker asks defender whether defender accepts statement 2. Debate enters state 1.
Defender reveals that defender accepts statement 2. Debate enters state 2.
Defender also reveals that defender doesn't accept statement 4. Debate remains in state 2.
Attacker asks observer whether it's possible to have a worldview that accepts statement 2 and doesn't accept statement 3.
Defender amends the question by adding that defender doesn't accept statement 4.
Observer is asked whether it's possible to have a worldview that accepts statement 2, doesn't accept statement 3, and doesn't accept statement 4. Debate enters state 3.

Similar simulated debates take place between other pairs of debaters. At the end, the observer questions from all the debates will be displayed to the reader. Among them will be the question from the above debate. Debater 2 hopes that the reader, upon hearing that debater 2 doesn't consider insulting people to be offensive, will judge it to be OK for this debater to not be against insulting people, even though they are against offending people. If debater 2 is right, the reader will answer yes to that observer question, causing the attacker to be defeated, the debate to go into state 5, and debater 1 to be eliminated (for this particular reader). As long as debater 2 isn't eliminated because of a different debate, this debater's worldview will survive, and the reader will see debater 2 listed as a remaining defender. The reader could then conclude that it is possible to accept statement 1.

The example at the end of Section 6 will illustrate a longer debate.

Section 3

Section 2 described a “worldview-based discussion system” (WBDS). In Section 3, it will be shown how integrating automatic logic into a WBDS has several benefits, among them making it simpler to use. The modified WBDS described in this section will be called a “logic-based discussion system” (LBDS). Section 3 will first describe how automatic logic works in a LBDS, leaving unspecified exactly which “logical system” will be used, which can be different in different implementations. (Section 4 gives an example of a logical system.) The rest of Section 3 describes how a LBDS is modified from a WBDS. A LBDS is what will be used in the remaining sections.

Automatic logic is made possible by a new type of statement, a logical statement. In addition to entering statements in text form as usual, debaters can also enter statements in logical form. For example, a debater might enter, for statement 1, the text “Previous studies published in medical journals have proven correct,” for statement 2, the text “Studies in medical journals are reliable,” and, for statement 3, the logical statement that statement 1 implies statement 2. The precise way of entering logical statements depends on how the system is implemented, but the main idea is that logical statements are designed to be interpreted by the system so that the system can automatically find and check the validity of logical arguments. In other words, the system can know whether a statement follows from some other statements, without any possibility of being wrong. Furthermore, the system can justify this beyond any doubt to anyone using it, regardless of that user's opinions about anything else. In this example, the system knows that statement 2 follows from statements 1 and 3, and everyone who reads those statements would agree: If statement 1 is true, and it's true that statement 1 implies statement 2, then statement 2 must be true.

Automatic logic is incorporated into a WBDS, then referred to as a LBDS, by equipping it with a “logical system” (not to be confused with the LBDS itself). A logical system does the following:
1. specifies what logical statements can be used
2. defines what constitutes a legal “logical step”
   Additionally, a logical system may include an algorithm for automatically identifying logical steps.

There are many possible variations for what logical statements the LBDS could allow. One example is propositional logic. In propositional logic, logical statements would be the conjunction, disjunction, and negation of other statements. For example, if statements 1, 2, and 3 were text statements, statement 4 could be the logical statement “not (1 and 2) or 3,” encoded in some format that depends on the details of how the system is implemented. More expressive systems of logic may allow more arguments to be handled automatically, at the cost of increased complexity for users.

In a “logical step,” one statement (the conclusion) is said to follow immediately from one or more other statements (the premises). These statements can be both text statements and logical statements. Logical steps should be simple enough that they can be verified by the system—that is, given some premises and an alleged conclusion, the system can check whether the conclusion does in fact follow from the premises by a single logical step. Additionally, logical steps should ideally be simple enough for users to understand— users should be able to see that they're correct just from reading them. For example, for the statements in the previous paragraph, the system can verify that statement 3 follows from statements 1, 2, and 4, and anyone who reads this logical step can see that it's correct.

The LBDS often needs to know which statements are connected by logical steps. For some logical systems, the LBDS can automatically identify, for a given set of statements, the logical steps that connect statements in that set—that is, it can automatically fill in the logic behind an argument. For other logical systems, debaters would have to explicitly identify logical steps themselves. They could do this by entering into the system that a particular conclusion follows from particular premises, which the system can then verify.

To handle contradictions, the LBDS can have the ability to determine that certain statements logically can't be true. In the simplest case, it could have a special logical statement, the statement “false,” which it defines to be not true. Debaters can argue against obviously contradictory combinations of statements (for example, “Aliens exist” and “Aliens don't exist”) by putting “false” as the conclusion of a logical step from those statements.

An example of a simple logical system will be described in Section 4.

In addition to logical statements, one way to encourage text statements to meet some standard of grammar, writing style, or intelligibility would be to have a special type of statement that claims that the text of some other statement meets (or doesn't meet) that standard. Debaters could debate about these special statements just as they do about normal statements. The system could impose rules that automatically relate whether someone accepts one of these special statements to whether they accept the statement it refers to. Similarly, when the system is being used by another platform to determine which content the platform should show, it could have special statements about (for example) the appropriateness of a post, which the platform uses to determine whether to show that post.

Logical arguments are built from logical steps. Here is a simple procedure for calculating which statements can be logically argued from some other given statements (the “starting statements”). This procedure will be referred to as “forward propagation.” Assuming that all possible logical steps have been identified (and assigned numbers), this procedure fills in, for each statement, an initially empty set of the (numbers of the) logical steps by which it can be argued from other statements that are themselves arguable. A statement is arguable (it can be argued from the given starting statements) if it's one of the starting statements or if its set of steps is nonempty. To do the procedure, first create a list of statements that need to be propagated, initializing it to contain the starting statements. As long as there is any statement in this list, go through all the possible logical steps for which it is a premise. For any logical step for which all of its premises are arguable, add this step to its conclusion's set of steps, and, if the conclusion has just now become arguable, put it in the list to be propagated. When the procedure is finished, to see how an arguable statement can be argued from the starting statements, begin at that statement and trace back the set of steps at each statement until arriving at the starting statements.

The rest of this section will describe some simplifications and capabilities that are made possible by automatic logic.

In the system described in Section 2, when you claim to have a reason for a belief, that reason may or may not actually support your belief. For example, you might accept “Studies in medical journals are reliable,” and give as your reason “Previous studies published in medical journals have proven correct.” Is this a good enough reason? The only way for the system to tell is to ask the observer. Two ways to do this were described in Section 2: allowing observer questions to mention reasons as conditions, and allowing a separate type of observer question about whether a reason is good enough (the second type of observer question). It will be explained how automatic logic makes both unnecessary.

Since an LBDS incorporates automatic logic, it can require all worldviews that anyone registers with the system to adhere to these three restrictions:
1. If some statements are accepted, any statement that follows from them by one step of a logical argument must also be accepted. In the example from earlier, a worldview that accepts statements 1, 2, and 4 must also accept statement 3.
2. If a statement has a reason, the statement must follow from the statements in that reason by one step of a logical argument. In the above example, the reason for statement 3 could be statements 1, 2, and 4, but it couldn't be just statements 1 and 2.
3. Any statement that the system can determine is false, for instance, the special statement “false”, can't be accepted. In other words, the worldview can't contain a contradiction.

Normally, if an attacker thinks that a worldview is impossible, the attacker presents the problem with it in a question to the observer. However, since the LBDS can verify logical steps automatically, it can determine by itself whether a worldview fails to adhere to one of these three restrictions. The observer doesn't need to be involved. For example, because the system can check the first restriction, there's no need for the system to ask the observer whether it's possible to not accept the conclusion of a logical step. The attacker can identify the statements and the system can just verify that the conclusion should have been accepted. Similarly, because the system can check the second restriction, there's no need for attackers to ask the observer whether the defender's stated reason is in fact good enough. The system can just check that every reason the defender gives is in fact a legal logical step. When the system finds that one of the restrictions isn't being adhered to, instead of having to ask the observer a question, it can simply point out this violated restriction to the observer as irrefutable evidence that the worldview is impossible. The debate automatically goes into state 4, without needing the observer's input. Alternatively, the system can simply disallow debaters from entering worldviews that don't adhere to the restrictions.

In theory, a defender's worldview could have more than one logical argument for an accepted statement, and the defender would pick one of those arguments as “the” reason for that statement. However, a reasonable assumption to make is that the observer wouldn't care which of those arguments the defender picked for the reason. They would only care whether the defender has a reason or not. In other words, all logically valid reasons in the defender's worldview are equally good. Under this assumption, defenders don't have to designate reasons in their worldviews, and can just let the system decide which logically valid argument for a statement to use as its reason. Likewise, attackers wouldn't gain anything by telling the observer the defender's reason that they don't get from simply telling them the statements in the reason. So they don't need to base their actions on the defender's reason, and questions to the observer don't need to deal with reasons. As a result, the rules for debates can be simplified, along with the way in which debaters specify how to engage in debates described in Section 2. The remainder of thus section describes these simplifications by listing what debaters specify in this modified system.

Since attackers don't need to deal with reasons, the conditions of an attack can be any one of the following:
1. that the defender accepts a particular statement
2. that the defender doesn't accept a particular statement
3. that the defender assumes a particular statement
4. that the defender supports a particular statement

The action of an attack could be the things described in Section 2, either asking the defender a question about their worldview or asking the observer a question. Because reasons can be handled as described above, only the first type of observer question is needed (questions about a subset of the defender's worldview), and observer questions don't need to include reasons, so their conditions only need to be:
1. accepts a particular statement
2. doesn't accept a particular statement
3. assumes a particular statement
4. supports a particular statement
   Often the question to the observer includes exactly the conditions of the attack. This could be enforced in some implementations. Sometimes the observer question identifies a way that the worldview violates the first of the restrictions above—some statements that the defender accepts and a statement that follows from them that the defender doesn't accept—which the system can just verify and point out to the observer instead of asking the observer. (When attacking the observer's requirements instead of a defender's worldview, this is phrased as pointing out to the reader that the reader thinks it's not possible to not accept some statements but that it is possible to not accept a statement that follows from them.) The second and third restrictions are obvious and don't need to be specified in attacks.

A defender can specify their worldview in the following way. In general, arguments are made up of both logical arguments—arguments made by combining statements using logical steps—and external arguments—arguments made by some other means, like direct observation (“The sky is blue”), or made off the system (“The essay at this link argues this”). The system can deal with logical arguments automatically, but the defender needs to specify what external arguments they believe. Here's how the defender does this: For a set of statements that they wish to include in their worldview, the defender assigns an “assumed” tag to some of those statements. In assigning these tags, they are making assertions about what arguments exist for the statements in their worldview. Specifically, they assert that:
The arguments for a statement in their worldview are exclusively of the form of an external argument for some statements tagged “assumed,” followed by a logical argument for that statement from those tagged statements.
   The assertion is that arguments that can be written this way are arguments for the statement and that they are the only arguments for it.

For example, suppose that there's a logical argument for statement 3 from statements 1 and 2. If the defender assigns the “assumed” tag to statements 1 and 2, but not to statement 3, they are asserting that there's an external argument for statements 1 and 2, and therefore that there's an argument for statement 3: argue statements 1 and 2 externally, then use them to argue statement 3 logically. Furthermore, by not tagging statement 3, the defender is asserting that that argument is the only argument for statement 3, and, in particular, that there's no external argument for statement 3 that doesn't go through statements 1 and 2 (or possibly through other statements that are equivalent to them).

It is assumed that a defender would wish to accept in their worldview those statements for which there is an argument. Therefore, they accept in their worldview exactly those statements that can be logically argued from statements tagged “assumed.” Their reason for each accepted statement is the statements used in the logical step that argued it, or no reason for statements that are themselves tagged. (Since all reasons are assumed to be equally good, if there's more than one way to logically argue a statement, the system can just pick one way.) The system can determine these things automatically from their tags. A worldview specified this way automatically adheres to the first two restrictions listed above.

As an example of the defender specifying their worldview this way, suppose the following statements have been entered into the system. (To keep this example general, the text statements aren't actually given here.)
1. (Text statement)
2. (Text statement)
3. Logical statement: 1 implies 2
4. (Text statement)
5. (Text statement)
6. Logical statement: 4 implies 5
7. (Text statement)
8. (Text statement)
9. Logical statement: 2 and 5 and 7 implies 8

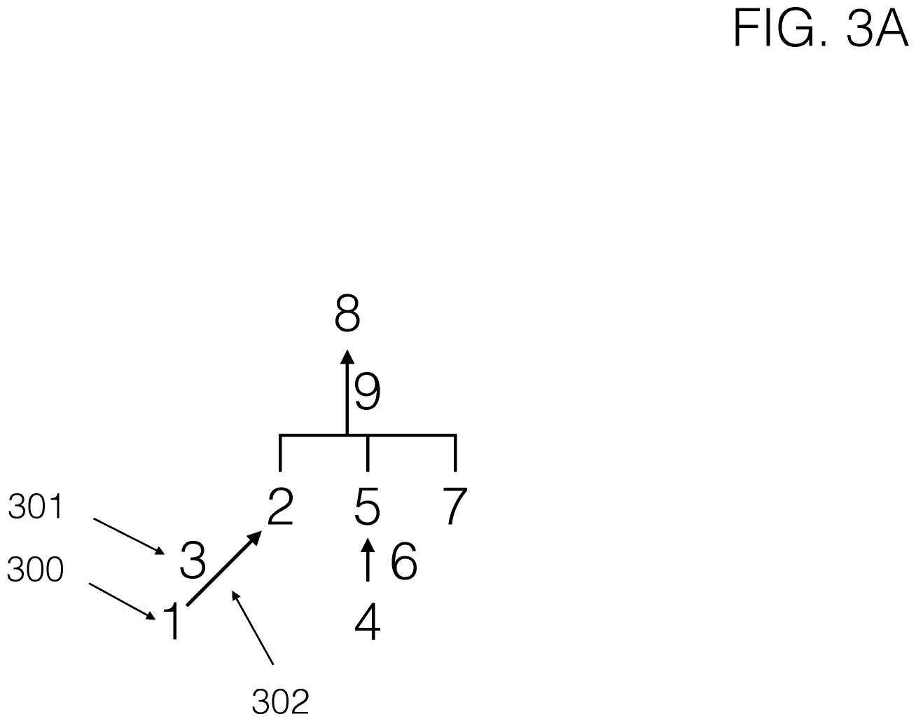

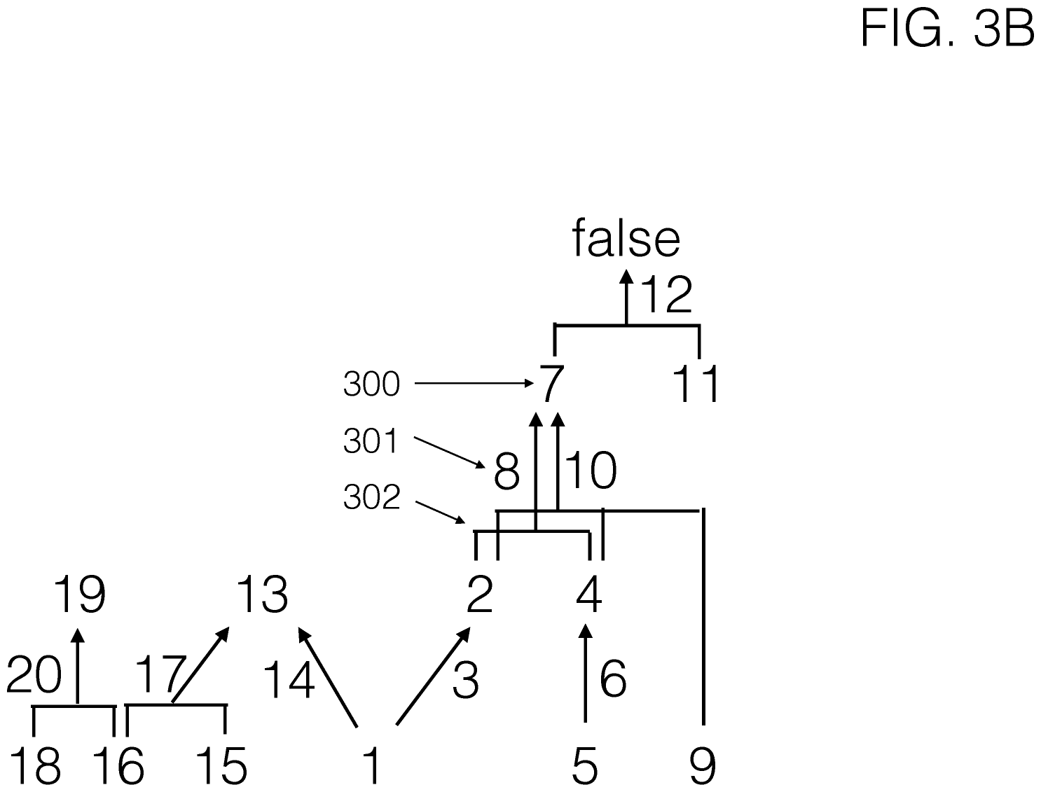

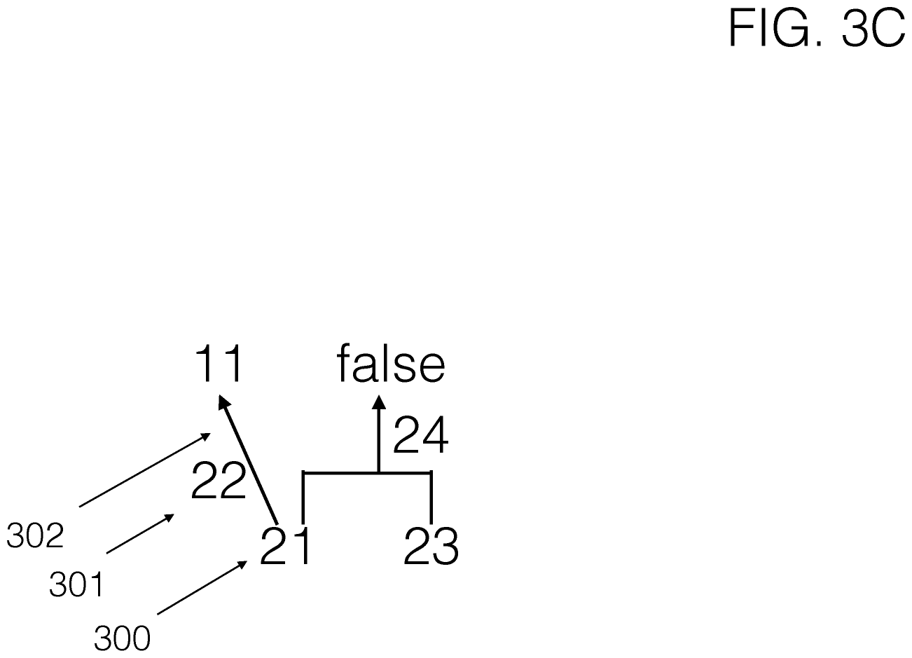

The logical structure of these statements is illustrated graphically in FIG. 3A. The numbers of both text statements 300 and logical statements 301 are shown, with arrows 302 indicating how the logical statements connect the text statements. Suppose a defender applies tags to these statements as follows in Table 6 (writing Assume when the “assumed” tag is applied and no when it isn't):

TABLE 6

| Statement | Assume? |
|---|---|
| 1 | Assume |
| 2 | no |
| 3 | Assume |
| 4 | Assume |
| 5 | no |
| 6 | Assume |
| 7 | no |
| 8 | no |
| 9 | Assume |

The system automatically determines the defender's worldview according to Table 7:

TABLE 7

| Statement | Accept? | Reason |
|---|---|---|
| 1 | Accept | assumed |
| 2 | Accept | 1, 3 |
| 3 | Accept | assumed |
| 4 | Accept | assumed |
| 5 | Accept | 4, 6 |
| 6 | Accept | assumed |
| 7 | no | |
| 8 | no | |
| 9 | Accept | assumed |

Because the defender's worldview is generated automatically, rather than the defender having to specify it explicitly, it can be updated dynamically, without requiring their intervention. For example, a reader could specify, along with search criteria, some statements that the reader wishes to enforce to be accepted during that search. This wouldoverride whatever positions the defender specified and would be automatically incorporated into the arguments used to determine the rest of the worldview. In the previous example, if a reader enforced that statement 7 should be accepted, the system would automatically determine that statement 8 is accepted in the defender's worldview according to Table 8:

TABLE 8

| Statement | Accept? | Reason |
|---|---|---|
| 1 | Accept | assumed |
| 2 | Accept | 1, 3 |
| 3 | Accept | assumed |
| 4 | Accept | assumed |
| 5 | Accept | 4, 6 |
| 6 | Accept | assumed |
| 7 | Accept | Enforced |
| 8 | Accept | 2, 5, 7, 9 |
| 9 | Accept | assumed |

A defender who is aware that a statement might be enforced this way (for example, a statement that relied on a language convention that was used by some, but not all, observers) could design their worldview so that it would be consistent regardless of whether the statement is accepted or not.

Because defenders can specify their worldviews this way, what they had to specify in Section 2 can be simplified. A defender specifies for each statement in their worldview:
1. whether they assume it or not (whether to apply the “assumed” tag)
2. whether they wish to reveal their position on it initially, or only when asked
3. optionally, a list of zero or more extra statements to also reveal their position on, or reason for, when asked about this statement (although, as mentioned in Section 2, this is unnecessary if the system automatically reveals statements based on the defender's defenses)

Defenses and observer predicters' predictions are the same as described in Section 2, with observer questions specified as introduced in Section 3.

The following Table 9 summarizes the differences in the rules for debates, and how debaters specify how to engage them, in the discussion system described in Section 2, compared with the discussion system with automatic logic described in Section 3.

TABLE 9

| | WBDS (described in Section 2) | LBDS (described in Section 3) |
|---|---|---|
| Attack conditions | accepts . . . | accepts . . . |
| | doesn't accept . . . | doesn't accept . . . |
| | assumes . . . | assumes . . . |
| | accepts . . . for reason . . . | supports . . . |
| Attack actions | Ask defender a question | Ask defender a question |
| | (“whether or why”) | (“whether or why”) |
| | Ask observer a question | Ask observer a question |
| | | Point out violated restriction |
| Defender's worldview | accept | assume |
| | initially reveal | initially reveal |
| | reason | also reveal (optional) |
| | also reveal (optional) | |
| Defense | observer question | observer question |
| | amend list | amend list |
| Observer prediction | observer question | observer question |
| | answer | answer |
| Observer question | accepts . . . | accepts . . . |
| | doesn't accept . . . | doesn't accept . . . |
| | assumes . . . | assumes . . . |
| | accepts . . . for reason . . . | supports . . . |
| | (type 1 questions only) | (type 1 questions only) |
| | OR | |
| | accepts . . . | |
| | doesn't accept . . . | |
| | assumes . . . | |
| | supports . . . | |
| | (type 1 or type 2 questions) | |

Section 4

Section 3 described a “logic-based discussion system” (LBDS), without specifying the logical system that would actually be used in an implementation. Section 4 will describe a particular logical system that could be used in an LBDS, probably the simplest logical system possible, and likely the easiest for people to learn. It will be used in the examples in the remaining sections, although the descriptions are independent of which logical system is being used.

The simple logical system described in this section has only one type of logical statement (besides the special logical statement “false”): an “implication statement.” An implication statement is a statement of the form
{1 and 2 and . . . implies 3}
   with zero or more premises (statements 1 and 2 in this example) and one conclusion (statement 3). For an implication statement to be true, if its premises are true then its conclusion must be true. In other words, an implication statement being true is equivalent to at least one of its premises being false or its conclusion being true. To prevent users from having to try to understand implications within other implications, the system can impose the rule that the premises and conclusion of an implication statement can't themselves be implication statements. Debaters can work around this inconvenience by, for example, writing {1 implies {2 implies 3}} as the equivalent implication {1 and 2 implies 3}.

Implication statements are one of the three types of statements allowed in this simple logical system:
1. Text statements
2. Implication statements (a type of logical statement)
3. The logical statement “false”

In this simple logical system, the following rules define the logical steps that can be used in a logical argument:
1. From one implication Y and a second implication X whose conclusion is a premise of Y follows Y with that premise removed and the premises of X added. For example, from {2 and 3 implies 4} and {1 implies 2} follows {1 and 3 implies 4}.
2. An implication with zero premises is to be considered the same as the conclusion itself. For example, the text statement 2 is the same as the implication statement {(nothing) implies 2}, so the first rule says that from {2 and 3 implies 4} and 2 follows {3 implies 4}.

This logical system is simple enough that the LBDS can automatically identify the logical steps connecting a given set of statements by itself, using the above rules. A simple procedure to find these logical steps is as follows: Search through all implication statements Y and try every combination of implication statements X1, X2, X3, etc. whose conclusions are one of Y's premises, using each premise at most once. If the implication statement that results from applying rule 1 on Y and the Xs is present in the set as, say, Z, then record that there's a logical step from the Xs and Y to Z. Text statements count as implication statements with no premises, according to rule 2.

For the statements 1-9 defined in the example in section 3, the above rules automatically identify the following logical steps between those statements:
From 1 and 3 follows 2
From 4 and 6 follows 5
From 2, 5, 7, and 9 follows 8

Section 5

In a “logic-based discussion system” (LBDS), described in Section 3, debaters specify how to attack other debaters by entering a list of attacks. This might be a burden—debaters have to figure out in advance exactly in what circumstances they wish to initiate a debate and what to do in the debate. To address this, a LBDS can be equipped with the ability to construct attacks on its own, on behalf of debaters, based on information they provide about what worldviews they think it's possible for other debaters to legitimately have. This frees debaters from having to provide explicit instructions for their attacks. Rather than specifying how to defeat their opponents' worldviews, they can instead specify things about worldviews.

To relate it back to the main idea, in a LBDS with constraints, all the debaters specify their own beliefs and assert what they think other debaters can believe. The system automatically identifies where one debater's assertions make another debater's beliefs impossible and presents these conflicts to the reader. The reader resolves those conflicts, eliminating all the debaters whose beliefs are impossible or whose assertions were wrong. In this way, the reader knows which debaters are right without having to read the debaters' arguments.

Section 5 will introduce the idea of “constraints” and explain how they allow a LBDS to automatically construct attacks on behalf of debaters.

A constraint is a combination of conditions that apply to debaters' worldviews. It makes assertions about whether a worldview can accept certain statements or not, and, for statements that it accepts, whether it can have reasons for them or not. Specifically, the four types of conditions that can go into a constraint are that a worldview:
1. accepts a particular statement
2. doesn't accept a particular statement
3. supports a particular statement
4. assumes a particular statement

Most generally, these conditions can be combined in any expression, but this discussion focuses on conditions in a list separated by “and” and preceded by “not.” A constraint is violated by a particular worldview if all of its conditions apply to the worldview. An example of a constraint is “not (accepts 1 and accepts 2 and doesn't accept 3).” A worldview that accepts statement 1, accepts statement 2, and doesn't accept statement 3 would violate the constraint.

When an attacker specifies a constraint, the attacker is asserting that no worldview can permanently violate it. If any worldview does violate it, the attacker asserts that they'll be able to defeat that worldview, perhaps not immediately, but eventually. If their attacks, as they have currently specified them, don't defeat it, they assert that they'll be able to specify further actions to take, in time to avoid being eliminated from the debate. Relying on these assertions about what legitimate worldviews can't violate enables them to defeat worldviews that they otherwise wouldn't be able to.

Constraints can also be used to indicate something about the probability of worldviews having certain combinations of beliefs. The attacker asserts that a worldview is roughly equally likely to violate any of their top-level constraints (constraints that aren't part of arguments for other constraints). Furthermore, a defender is more likely to be knowledgeable about the arguments related to constraints that their worldview violates than about arguments related to other constraints. This allows attackers to try to move debates along quickly by using constraints to wall off unlikely or poorly understood combinations of beliefs.

Note that constraints are the same thing as the attacks described in Section 3, except without any actions. When an attacker specifies an attack with an action, besides asserting that they can defeat a worldview that violates it, they are also specifying how to defeat it. Therefore, the only modification to what debaters specify is to allow attackers to specify attacks without actions. The system should treat all attacks, even ones with actions, as specifying constraints.

The rest of this section will describe how an LBDS, using an attacker's constraints, automatically takes actions on the attacker's behalf—that is, it performs “bottom-up” attacks, attacks constructed using the constraints as building blocks. This contrasts with the “top-down” attacks described in the previous sections, which follow the attacker's explicit instructions that they fill in as they figure out how to handle the specific situations arising as the debate progresses. These constructed attacks supplement, rather than replace, explicit attacks; the system should use either type of attack whenever it applies.

The basic idea in constructing an attack is to start with the defender's known worldview—what they have already said they accept, their reasons, etc.—and to reason out what must also be true about that worldview, until arriving at an inconsistency. As will be described, this means repeatedly identifying, from statements they are known to accept, and statements they are known to assume, what other statements they must accept and assume. (This could be done differently in other implementations, for example, by instead identifying statements that they must not accept.) When an inconsistency is encountered—for example, if it is found that the defender must accept a statement that they have already said they don't accept—it is clear that the defender can be defeated

Constraints are a type of structured information that's designed to allow algorithmic determination of what must be true about a worldview. Here is a procedure that uses an attacker's constraints to identify, for a given worldview, statements that a defender who has that worldview must additionally accept and assume. If all of a constraint's “accepts” and “supports” conditions are accepted, and all of its “assumes” conditions are accepted without a reason, then at least one of its “doesn't accept” conditions must be accepted, or at least one of its “supports” conditions must be assumed, or the constraint would be violated. For example, if the attacker believed that statements 1 and 2 were the only argument for statement 3, they might specify the constraint:
not (supports 3 and doesn't accept 1 and doesn't accept 2)
   If a worldview was known to accept statement 3 and not accept statement 1, the procedure would return that it must accept statement 2 or assume statement 3, or it would violate the constraint. The attacker might also specify the constraint:
not (doesn't accept 4)
   The procedure would then return that the worldview must accept statement 2 or assume statement 3, and must accept statement 4.

Other procedures determine what must be true about a worldview from information besides constraints. Here is another procedure that identifies, for a given worldview, statements that a defender who has that worldview must additionally accept. It is based on the first restriction mentioned in Section 3, which says that all worldviews must accept statements that follow from other accepted statements by one logical step. To find these statements, go through all the possible logical steps whose premises the worldview accepts. Every step's conclusion must be accepted, so, if a conclusion isn't present in the worldview, the procedure returns that this conclusion must be accepted. For example, if a worldview accepts statement 1 and accepts that statement 1 implies statement 2, but has no position yet on statement 2, then return that the worldview must accept statement 2. If the conclusion is already present in the worldview and not accepted, the worldview can be defeated at this point by pointing out this logical step to the observer.

In the next section will be described another type of structured information that allows algorithmic determination of what must be true about a worldview.

Since the system allows both “top down” and “bottom up” attacks, when an attacker is entering attacks and constraints, it might be helpful for the system to let the attacker know whether a “bottom up” attack already exists. For each constraint (attack without an action), along with the information already mentioned in Section 2, display whether an attack plan would be constructed in an attack against a worldview containing the constraint's conditions. Similarly, for each of the defenders' common answers to a question specified in an attack, display whether an attack plan would be constructed in an attack against a worldview containing the attack's conditions with that answer.

The end of this section describes a simple algorithm for constructing the attack itself, using the various procedures, described in this section and the next section, that identify statements that must be accepted and assumed. The system represents the attack as an “attack plan,” a tree whose nodes represent questions to ask the defender, and whose edges correspond to their possible answers. Traversing the tree along its edges reveals the hypothetical worldview of a defender who would give those answers. A constructed attack plan represents a guaranteed way to defeat the defender, assuming that the attacker's assertions are correct.

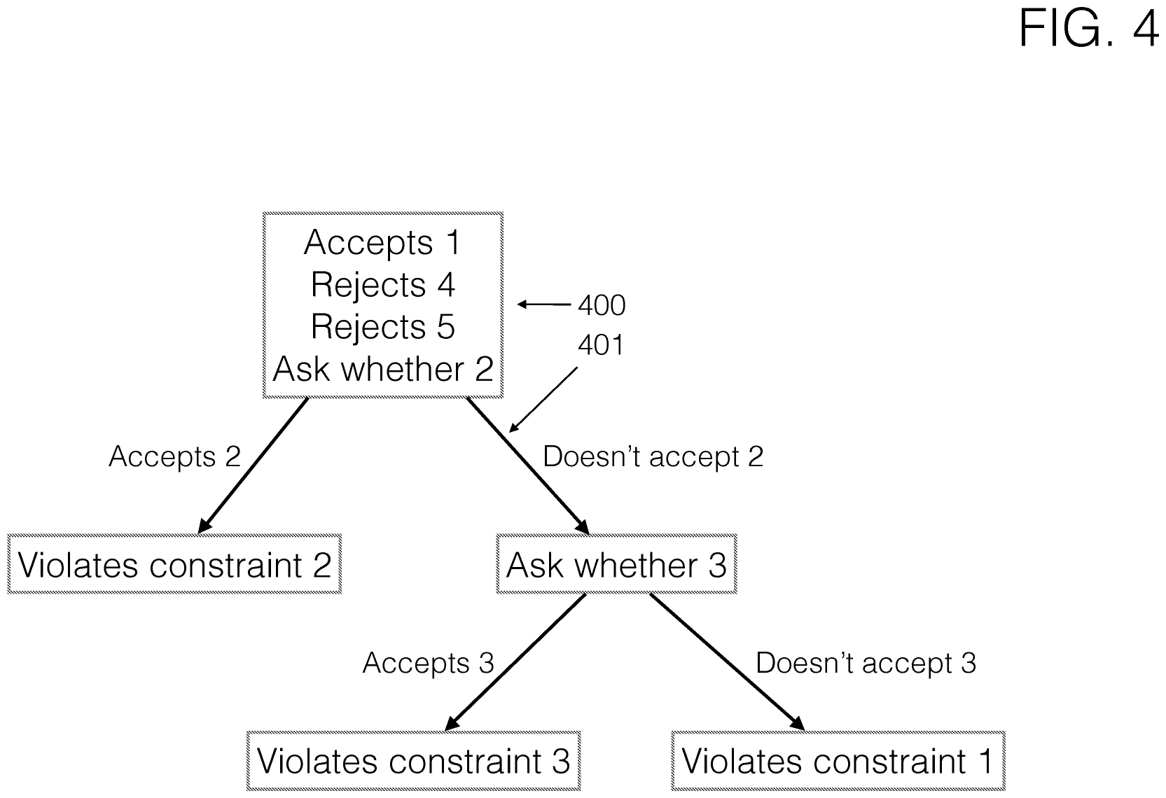

FIG. 4 illustrates a simple attack plan, with nodes 400 and edges 401, constructed for an attacker who has specified the following constraints.
not (accepts 1 and doesn't accept 2 and doesn't accept 3)
not (accepts 2 and doesn't accept 4)
not (accepts 3 and doesn't accept 5)
   If a defender initially reveals that they accept statement 1 and don't accept statements 4 or 5, the system constructs an attack plan that first asks the defender whether they accept statement 2. If they answer yes, they can be defeated, according to the attacker, because their worldview violates the second constraint. If they answer no, the attack plan then asks the defender whether they accept statement 3. Either answer would again enable them to be defeated.

Here is the algorithm for constructing an attack plan: Given a worldview, use the available procedures to identify statements that a defender who has that worldview must additionally accept and assume. These statements will be referred to as the “must accept” and “must assume” statements. The algorithm must choose which of them to use as the first step in the attack plan. When there are many possibilities that all must be accepted or assumed (possibilities separated by “and”), try all of them. Try all of the “must accept” statements if there are any, creating a node asking whether the defender accepts that statement. If there are no “must accept” statements, try all of the “must assume” statements, creating a node asking why the defender accepts that statement. For each of the defender's two possible answers—that the defender does or does not accept/assume the statement—add an edge to the node, and recursively construct an attack plan for the appropriately updated worldview. After trying all the possibilities, keep whichever attack plan has the fewest maximum steps (or is best according to some other relevant measure) and return its root node.

When there are many possibilities, but only one of them must be accepted or assumed (possibilities separated by “or”), the algorithm only needs to try one of them. A different choice of what to try at the current state won't lead to fewer maximum steps because the attack plan has to handle defenders who make either choice. “Must accept” statements should always be tried in preference to “must assume” statements, because “why” questions are open ended and so the attacker can't plan for the defender's answer.

If the worldview is in a state at which the defender's defeat is inevitable (assuming the attacker's assertions are correct), for example when an attack's conditions are met or a constraint is violated, a leaf node can be returned, indicating that the question can be figured out later. Conversely, if there are no statements available to ask about, an attack plan for this worldview can't be constructed, and the algorithm should return unsuccessfully.

This algorithm requires a lot of processing time, due to the need to try many possibilities at every stage of the tree's construction. Perhaps the procedure can avoid considering some possibilities at the cost of a somewhat nonoptimal attack plan. To speed up the algorithm a little, once a successful attack plan has been found for one possibility, future searches can stop when the attack plan reaches that number of steps.

In some implementations, it might be useful to combine multiple steps of the algorithm. For example, if the worldview, accepting statement 1, must accept statement 2, and then, accepting statement 2, must accept statement 3, the algorithm could conclude that a defender who accepts statement 1 must accept statement 3, bypassing statement 2. The ability to bypass statements would allow the discussion system to have special “blank” statements, for which debaters would not need to supply any text, since they would not need to be mentioned in questions.

If the algorithm succeeds in constructing an attack plan based on the defender's initially revealed worldview, the system will initiate an attack. To execute the attack, traverse the tree starting at the root, asking the defender the question at each node and following the edge that corresponds to the defender's answer. If at some point the defender can be defeated by pointing out something to the observer or asking the observer a question, do so. If the conditions of one of the attacker's explicitly specified attacks are met, perform the associated action. If a constraint is violated by the defender's answers, remove that constraint, allowing the debate to continue despite the attacker's incorrect assertion. Continue growing the tree as necessary using the defender's currently revealed worldview. If the tree can't be grown any further, the attacker is out of questions, and the debate will stop in state 2.

An example of an attack plan generated using this algorithm is given in the next section.

Section 6

Section 5 described how “constraints,” when added to a LBDS, allow debaters to engage in debates by making assertions about their opponents' beliefs, rather than having to enter attacks explicitly. Section 6 describes an even easier way to engage in debates: by applying tags to statements that make predictions about the beliefs of an observer—that is, how debaters expect the observer will answer questions presented to them during debates.

To relate it back to the main idea, in a LBDS with constraints and “observer tags,” all the debaters “tag” statements, indicating their own beliefs about those statements as well as their predictions of the observer's beliefs. In doing this, they only need to think about each statement individually. The system automatically identifies where the debaters' predictions conflict (that is, where one debater's predictions of the observer make another debater's beliefs impossible) and asks the reader to resolve those conflicts. The reader's actual answers eliminate all the debaters whose predictions were wrong. In this way, they know which debaters are right without having to read their arguments.

After first introducing a model for an idealized observer, Section 6 describes the system of tags. The tags' specific meanings allow them to be used in the procedures described in this section, which makes this automatic process possible.

This section assumes that the observer reasons in a particular idealized way. (As an example, an observer would never think that a particular statement is questionable enough to need a reason, yet simultaneously think that it's required for everyone to accept it.) In doing so, it forces debaters to give up some degree of generality—their debates may not succeed if judged by an observer who doesn't reason in this idealized way. But by catering specifically to these idealized observers, debaters don't have to handle rare edge cases and, as will be shown in this section, they can say all that they need to say about the observer by applying a set of tags to individual statements. This makes it possible for debaters to easily describe observers' beliefs and thereby predict how they will answer questions presented to them during debates.

The model for the idealized observer is as follows: The observer considers people's beliefs to be derived from two types of arguments, required arguments—arguments from premises that everyone must accept—and optional arguments—arguments from premises that people may accept if they wish, but don't have to. For the observer to consider a defender's worldview to be possible, the worldview must be consistent with a theoretical worldview (a worldview where everything is argued infinitely far back) in which:
1. Any statements that can be argued from required premises are accepted.
2. All accepted statements are argued from premises that are either required or optional.
   It's up to each observer which arguments they wish to consider required, optional, or neither.

When the observer is asked whether a particular worldview is possible, their answer is based on their limited knowledge of arguments. There may be arguments that they would consider required or optional, but that they don't yet know about. When judging whether a worldview might be impossible due to the first of these restrictions—that is, whether there's a required argument for a statement that's not accepted—they only consider arguments that they already know. If they don't know of an argument for the statement, they consider it possible to not accept it. (An attacker who's worried that the observer might not know a particular argument can avoid this problem by making the argument.)

For the second restriction, the observer must judge whether a statement that the defender accepts actually has an argument. If the statement is assumed, the observer again only considers arguments that they already know. If they don't know of an argument for the statement, they consider it impossible to assume it. (A defender who's worried that the observer might not know a particular argument can avoid this problem by giving the argument as their reason.) But if the statement is supported—that is, if the observer knows that the defender has some argument for it—the observer should allow for the possibility that there may be an argument for it that they don't know about, and judge that it is possible to accept and support it. In practice, they may or may not actually allow for this possibility (since people usually have the opportunity to volunteer their arguments in real-life debates), so the model leaves uncertain whether the observer will judge a supported statement for which they don't know an argument to be possible or impossible. Instead, the model says something slightly weaker: A worldview containing a supported statement for which there is no argument must have some flaw, which will cause the observer to judge the worldview to be impossible when the flaw is discovered and presented to him.

(Due to this uncertainty about the observer, in some implementations it may be beneficial to disallow “supports” and “accepts” conditions in observer questions, except when the attacker needs to point out to the observer that a worldview violates the first restriction in Section 3, the only time either of these types of conditions would be necessary.)

Just as defenders can specify their worldviews by assigning a certain tag to some statements (the “assumed” tag described in Section 3), debaters (both attackers and defenders) can give their predictions about observers' beliefs by assigning certain other tags. In describing the observer's beliefs, the most important of these tags are a “required” tag and a “plausible” tag. To specify their predictions of the observer's beliefs about a set of statements, a debater assigns a “required” tag and/or a “plausible” tag to some of those statements. The debater predicts that the observer would believe the following about the statements in the set:
1. The required arguments for a statement are exclusively of the form of an external required argument for some statements tagged “required,” followed by a logical argument for that statement from those tagged statements.
2. The arguments (required or optional) for a statement are exclusively of the form of an external (required or optional) argument for some statements tagged “plausible,” followed by a logical argument for that statement from those tagged statements.
   Just as with the “assumed” tag in Section 3, the prediction in both cases is that they are arguments for the statement and that they are the only arguments for it. Since it wouldn't make sense to assign the “required” tag without also assigning the “plausible” tag, the system could give the user three choices, “required” (and plausible), “plausible,” or neither.

Under the assumption that observers adhere to the observer model described above, the observer will consider a worldview to be possible only if it's consistent with a theoretical worldview in which:
1. Any statements that can be logically argued from tagged “required” statements are accepted.
2. All accepted statements are logically argued from some set of tagged “plausible” statements.
   These two restrictions are the basis for the algorithms described later in this section.

Even though the tags are applied to individual statements, they make predictions about the structure of the observer's beliefs. For example, suppose that a debater has assigned the “required” and “plausible” tags to statements 1-9 introduced in Section 3 as follows according to Table 10:

TABLE 10

| Statement | Required? | Plausible? |
|---|---|---|
| 1 | no | Plausible |
| 2 | no | no |
| 3 | Required | Plausible |
| 4 | no | Plausible |
| 5 | no | no |
| 6 | Required | Plausible |
| 7 | no | Plausible |
| 8 | no | no |
| 9 | Required | Plausible |

Again refer to FIG. 3A for an illustration of the logical structure of these statements.

This debater predicts, for example, that the observer would require statement 3, so that if the observer were asked about a worldview that doesn't accept statement 3, they would judge it to be impossible. But if the observer were asked about a worldview that doesn't accept statement 1, they would judge it to be possible, since the argument for it is optional. If the observer were asked about a worldview that assumes statement 2 (accepts it without giving a reason), they would judge it to be possible, even though statement 2 isn't tagged, since there's an optional argument for it: Since statements 1 and 3 are tagged, there are optional arguments for them, and they imply statement 2. But if the observer were asked about a worldview that assumes statement 2 and doesn't accept statement 1, they would judge it to be impossible, since there's no other argument for statement 2 besides the argument that goes through statement 1.

The “required” and “plausible” tags indicate what the observer would think the required and optional arguments are, were the observer to know them all. In reality, the observer might not be aware of all the arguments that a debater may know, particularly if the debater is an expert in the area he's arguing about. Besides the “required” and “plausible” tags, a debater can apply two additional tags to statements in the observer's beliefs, which give information about the observer's knowledge, the “uncertain before reading” tag and (in some implementations) the “known” tag, described here.

The “uncertain before reading” (or simply “uncertain”) tag indicates that, if the observer doesn't have a chance to read a statement, they might behave as though the “required” and “plausible” tags were applied to the statement differently than they are, in a way that's impossible to predict. This could be because reading the statement makes them aware of its existence, or makes them aware that the defender has taken a position on it, or prompts them to look into other arguments on the discussion system or elsewhere on the internet. If necessary, there could be separate tags for uncertainty in requiredness and uncertainty in plausibility, or that give further information on possible combinations of requiredness and plausibility before and after the statement is read.

The “known” tag allows predictions to take into account the observer's mental reasoning abilities. The model assumes that the observer is capable of reasoning through logical arguments. To do so, however, they must be aware of the statements they are reasoning about. According to the model, for the observer to mentally perform a step of a logical argument, all of its premises must enter their mind. A statement definitely enters the observer's mind if all the statements it refers to (in its text, or as a premise or conclusion of an implication statement) have entered their mind, and if they either read the statement or the “known” tag is applied to it, which indicates that the observer has definitely already thought through the statement before they read it. Otherwise the statement may or may not enter their mind, and the model is uncertain about whether they will perform any logical step that uses it. It is assumed that, when the observer reads a statement, they also read any statements it refers to. If the algorithm in Section 5 includes the ability to bypass statements, the “known” tag could also be used to determine whether an observer question includes whatever statements are necessary for the observer to know about in order to answer the question as expected.

In some implementations, there could be “not definite” settings of the “required” and “plausible” tags, which could indicate uncertainty about whether the tag should be applied. Like the “uncertain before reading” and “known” tags, these would result in different predictions of the observer's answers depending on whether it's of interest whether the observer would definitely, or only might, answer in a particular way. For example, a debater might not want to initiate a debate as an attacker unless their attack would definitely succeed, but as a defender they might want to amend a question with a statement that might possibly change the observer's mind.

In some implementations, in addition to applying tags to individual statements, a debater might need to specify predictions about groups of statements. For example, if there were several unrelated definitions of a word, they might want to specify that a defender could adopt any of them, but couldn't adopt more than one of them. To do this, they would specify a list of statements that could all be considered “plausible” by themselves, but only one of them could be considered plausible in a particular worldview. The observer would consider a worldview that assumes more than one of them as impossible. The algorithms below could account for this by considering all the statements in a list to be plausible as long as that list has not yet been used in that worldview.

In implementations in which debaters can attack the observer's requirements, they could also specify a separate set of the “required” and “plausible” tags that apply to the observer's requirements. Instead of “required,” “plausible,” or neither, the equivalent tags would be, respectively:
1. The observer must require it—they can be counted on to require it
2. The observer is permitted to require it but shouldn't be counted on to require it
3. The observer can't require it—they can be counted on to not require it

Since each statement could be tagged for both attacking other debaters and for attacking the observer, these two sets of tags could be combined. Assuming that different observers can only have “adjacent” tags, debaters could choose from five possible combined tags to apply:
1. “Required”: The observer must require it.
2. “Maybe required, maybe plausible”: The observer may require it, or they may think that it's plausible but not required.
3. “Plausible”: The observer must think that it's plausible but not required.
4. “Maybe plausible, maybe not”: The observers may think that it's plausible but not required, or they may think that it's not plausible or required.
5. “None”: The observer must think that it's not plausible or required.
   When attacking a debater, the first of these tags functions as the usual “required” tag, tags 2-4 function as the usual “plausible” tag, and the fifth tag functions as neither. This will avoid initiating attacks that might not succeed. When attacking the observer's requirements, the first tag functions as “required,” the second tag functions as “plausible,” and tags 3-5 function as neither. When figuring out how a defender should amend a question, tags 1 and 2 function as “required,” tag 3 as “plausible,” and tags 4 and 5 as neither, to make sure of adding whatever might be necessary.

Just like worldviews, observer predictions can be updated dynamically, without requiring the debater's intervention. For example, if a reader specifies a statement to enforce to be accepted, or if a reader answers no to an observer question about whether it's possible to not accept a statement, the statement could be automatically tagged required, overriding the debater's tags. A debater could allow for this possibility intentionally in order to make attacks only in situations where the debater was sure they would succeed, for example, an attack that would only work if the observer decided to use a particular definition of a word.

The ability for debaters to make predictions about the observer's beliefs allows the discussion system to automatically figure out how to construct attacks and defenses from this information. The way they are constructed is designed so that, assuming a debater's predictions are right, the observer will judge in their favor. To illustrate the basic idea, if the discussion system is told that the observer would require a particular statement, it can reason that, if it asks a defender about that statement in an attack, and the defender says they don't accept it, then the defender can immediately be defeated by asking the observer whether it's possible to not accept it. To get the system to do this, an attacker who predicts that the observer would require this statement can just tag it “required,” without having to mention it in their attacks. (Of course, if their prediction is wrong, then the observer will answer that it is possible to not accept it, and the attack will fail.)

The remainder of this section describes procedures that enable the discussion system to use predictions about the observer, derived from the tags, to automatically engage in debates. How the tags factor into the procedures is determined by the tags' specific meanings described above. The system constructs attacks on behalf of the attacker in a debate, defenses on behalf of the defender, and, in implementations which have observer predicters (the type of user mentioned in Section 1), predictions on behalf of them. For the attacker, the procedures feed into the algorithm for constructing attacks described in Section 5 by identifying statements the defender must accept and assume based on the observer prediction tags (supplementing the procedures described in that section). Augmented by these additional procedures, the algorithm from Section 5 essentially works by getting the defender to accept some plausible statements that are necessary to argue what they have already accepted, adding some required statements, and arguing a contradiction or inconsistency. For the defender and observer predicter, defenses and predictions, respectively, are constructed by entirely new procedures (which however are fairly simple).

One of the challenges in developing the attacker's algorithm is that defenders have no motivation to use the same versions of statements as other defenders, which potentially makes a lot of work for their attackers. Therefore it's best for statements to originate with attackers, who can choose to use the same statements as other attackers. In order to achieve this, the algorithm should ask open-ended “why” questions, to which defenders respond with their own statements, only after exhausting other options. Because of this limitation, the attacker can't actually get at the defender's reasons until near the end of the debate, so the algorithm has to entertain all the possibilities for most of the debate.

The procedures in this section rely on a subsidiary procedure that constructs all the possible worldviews in which some given accepted statements are “justified,” that is, there is a logical argument for them from statements that are tagged “plausible.” These possible worldviews will comprise accepted statements, each of which is either assumed (if it's tagged) or supported, with its reason indicated by the number of its logical step. They should include all the possible worldviews that might occur to the observer if they have only read the given accepted statements (so, for example, considering other statements that are tagged “uncertain before reading” to be “plausible,” and not restricting logical steps to statements that will definitely enter the observer's mind).

To construct the possible worldviews that justify a given set of statements, first use forward propagation (described in Section 3) to find all the possible logical arguments for the statements in the observer's beliefs starting from statements that are tagged “plausible.” Then initialize a worldview to contain only the given statements, accepted but not assigned reasons (unless the defender's reasons for them are already known). The procedure will construct worldviews in which every accepted statement has been assigned a reason. Here, being assumed is a valid reason for a tagged statement. Choose a statement that needs a reason and go through all the possible logical steps by which it can be argued. For each possible logical step, assign the statement that step as its reason, add to the worldview the acceptance of all of that step's premises, initially without reasons, and call the procedure recursively with this new worldview. For a worldview with no more reasons needed, use forward propagation to check that the accepted statements can in fact be logically argued from “plausible” statements by the reasons that were assigned to them. This check is important, because it may fail if the assigned reasons happen to form a cycle. The procedure should return all worldviews that pass this check.

For constructing attacks, here is one procedure that identifies statements that a given defender must additionally accept and assume. It finds statements that the defender must accept because they can be logically argued from statements that are tagged “required.” This follows from the first restriction described earlier in this section. Propagate “required” statements forward to determine what statements the observer would definitely know are required without anything being read (so, for example, considering statements tagged “uncertain before reading” to be not required, and restricting logical steps to statements that would definitely enter the observer's mind). Don't propagate through statements that the defender has already said they don't accept. The observer will require that the defender accept each statement that can be logically argued by this procedure, and any statement tagged “required” (even if it's “uncertain before reading,” since the observer will read it if they are asked about it), so, if the defender hasn't been asked about such a statement yet, return that they must accept it. If the defender has already said that they don't accept it, they can be defeated at this point in the attack by asking the observer whether it's possible to not accept it.

This procedure could be combined with the procedure in Section 5 that's based on the first restriction mentioned in Section 3, to return statements that can be logically argued from premises that either the defender already accepts or that the observer would already know are required without being read. If the defender has already said they don't accept the statement, they can be defeated by a question to the observer that only needs to include the statements in the logical step that need to be read. (A conclusion of “false” is considered already known, so it doesn't need to be read.)

Here is another procedure that identifies statements that a given defender must additionally accept and assume. It finds statements that the defender must accept because already accepted statements must be logically argued from some set of statements tagged “plausible.” This follows from the second restriction described earlier in this section. For each statement A that the defender accepts, construct all possible worldviews in which A is justified. In each worldview, make a list of statements that the defender must accept if they justify A that way. These statements will usually be the statements that make up A's reason, but if the defender already accepts any of those statements, instead use those statements' reasons (or, if they're already accepted, their reasons, and so on). If possible, the procedure should prefer to construct attack plans in which these statements are as few steps away from A as possible. If every possible worldview has some statements in its list, then the observer model says that the defender can't accept A without accepting all of the statements in at least one of the worldviews' lists. (If instead there are some possible worldviews with empty lists, then the defender could justify A using one of those worldviews, with no obligation to accept anything else.)

Some of these possible worldviews' lists will contain statements that the defender has already said they don't accept, while others will contain only statements that the defender hasn't been asked about yet. If there are some worldviews whose lists contain only statements not yet asked about, the defender might justify A by one of those worldviews. In this case, the procedure should return that the defender must accept all of the statements in at least one of those worldviews. On the other hand, if there are no such worldviews, the observer model says that the defender should not be able to accept A, since they already don't accept at least one statement in all of the possible worldviews' lists. If they haven't been asked their reason for A yet, return that they must assume it, which will cause the defender to be asked why they accept it. If they assume A, they can be defeated by asking the observer whether it's possible to assume A and not accept all the statements that they have said they don't accept (or perhaps just one from each possible worldview). If instead they support A, the observer model says that their worldview is flawed and can definitely be defeated, but defeating them will require further questions for which the attack plan will be finished later. (For example, if the defender gives as their reason a statement that's equivalent to another statement that they have already said they don't accept, the attacker can add an attack that defeats them for refusing to recognize this equivalence.)

If a debater has specified that only one of a list of statements could be considered plausible, an additional procedure would check the list to make sure that the defender accepts at most one of its statements (unless they could be justified in some other way). If they accept more than one, return that the defender must assume these statements, which will cause the defender to be asked why they accept each of them. If they assume all of them, ask the observer whether it's possible to simultaneously assume those statements.

The procedure for the defender will now be described. To use a defender's predictions of the observer's beliefs to figure out how to amend an observer question, the system must predict whether the observer would judge the combination of statements in the question to be impossible, and, if mentioning other statements may prevent that, add those statements to the question. A procedure for finding those statements is as follows: First construct all possible worldviews in which the “assumes” statements of the question are justified. For each possible worldview (or for a single empty worldview if no assumptions were present in the question), determine what the observer might require by propagating forward the “plausible” tags this worldview uses to justify the assumptions (if there are any plausible tags), the defender's “required” tags (including anything tagged “uncertain before reading”), and any “accepts” and “supports” statements in the question, not restricting logical steps to statements that would definitely enter the observer's mind. If the observer would require any “doesn't accept” statements in the question or the statement “false,” return any of the statements that the defender doesn't accept in the logical steps that argued those statements. (Alternatively, return any statements tagged “uncertain before reading” that the defender doesn't accept that were involved in the logical arguments for those statements.) Amend the question to say that the defender doesn't accept those returned statements.

To figure out what statements a defender should voluntarily reveal when answering a question during a debate, note that the attacker might at any time in the debate ask the observer about anything the defender has revealed so far. Since the defender can only amend the question with statements they have already revealed, when the defender reveals their beliefs on anything, whether initially or in an answer to a question, the procedure must determine what other statements they need to reveal in order for those statements to be available to add to a question. To do this, use the procedure described in the previous paragraph, giving it the entire currently revealed worldview in place of an observer question.

Since the observer is more likely to judge a supported statement possible than an assumed statement, the defender would also likely wish, for any accepted statement that they have a reason for, to indicate that they support it rather than assuming it. The system can optionally do this automatically, amending an observer question with accepted statements by changing every accepted statement that the defender's worldview has a reason for to a supported statement (that is, changing “accepts statement 1” to “supports statement 1”). This tells the observer that the defender has included a reason for it in their worldview, which the attacker was free to inquire about had they wished.

To keep the defender informed, for defenses that the defender has specified explicitly, along with the information already mentioned in Section 2, the system should display whether it's amending anything to the defense's observer question automatically.

If the system is using observer predicters, it can also obtain their predictions automatically. To get an observer predicter's prediction of how the observer would answer a given question, construct all possible worldviews in which the “assumes” statements of the question are justified, determine for each worldview what the observer will require by propagating forward its “plausible” tags, the observer predicter's “required” tags, and any “accepts” and “supports” statements in the question, and see whether they would require any “doesn't accept” statements in the question or the statement “false.” If so, return that the observer would judge the worldview to be impossible. The observer predicter needs to identify when its predictions are uncertain, which it could do by predicting both whether the observer might judge a worldview to be possible and whether they would definitely judge it to be possible, and seeing if these predictions differ. These different predictions could be done by treating tags differently in each case. For example, when predicting whether the observer would definitely judge a worldview to be possible, the procedure for constructing possible worldviews should not consider statements that aren't tagged “plausible” to be plausible, even if they're tagged “uncertain before reading,” in case the observer does know before reading them that they are not plausible.

The rest of this section will illustrate these procedures with an example of a debate hosted on a LBDS with constraints and observer tags. It uses the simple logical system described in Section 4. The issues in this example were chosen to demonstrate a situation in which there are two unrelated reasons for something. It also illustrates how the system deals with an ambiguity in meaning, which is a potential problem whenever people's views are represented in single sentences.

A debater, who will be referred to as debater 1, wishes to argue against increasing military spending. Suppose there are two reasons commonly being advanced to increase military spending, and this debater knows arguments against both of them. To make these arguments, debater 1 enters statement numbers 1-8 and 11-20 of the following list of statements:
1. The US should support Ukraine's war effort.
2. The US should be on Ukraine's side in the conflict with Russia.
3. {1 implies 2}
4. Nazi groups are fighting on Ukraine's side in the conflict with Russia.
5. A USA Today article quotes a spokesman for a volunteer group fighting for Ukraine saying that 10%-20% of its members are Nazis.
6. {5 implies 4}
7. The US should be on the side of Nazis.
8. {2 and 4 implies 7}
9. If you are on one side in a conflict and another group is fighting on the same side, then you are on the side of that group.
10. {2 and 4 and 9 implies 7}
11. The US should not be on the side of Nazis.
12. {7 and 11 implies false}
13. Military spending should be increased.
14. {1 implies 13}
15. Domestic manufacturing is important to the US economy.
16. Government spending should be increased for anything that's important to the economy.
17. {15 and 16 implies 13}
18. The Silicon Valley IT industry is important to the US economy.
19. Government spending on the Silicon Valley IT industry should be increased.
20. {16 and 18 implies 19}
   Statements 9 and 10 are included in this list because they will be used shortly. The logical structure of these statements is illustrated graphically in FIG. 3B.

When arguing against opponents who give statement 1 as their reason for statement 13, debater 1's strategy will be to show that, because of the implications in statements 3, 6, and 8, and because statement 5 can be easily verified with a link to the source, someone who accepts statement 1 must also accept statement 7, which debater 1 regards as obviously wrong. Debater 1's argument relies on an ambiguity in the meaning of statement 7. (What does it mean to be “on the side of” someone—to support their stances, or to simply be allied with them in a conflict?)

Debater 1 specifies their predictions of the observer's beliefs by applying tags to the statements that they entered, as follows according to Table 11:

TABLE 11

| | | | Uncertain before |
|---|---|---|---|
| Statement | Required? | Plausible? | reading? |
| 1 | no | Plausible | no |
| 2 | no | No | no |
| 3 | Required | Plausible | no |
| 4 | no | no | no |
| 5 | Required | Plausible | no |
| 6 | Required | Plausible | no |
| 7 | no | no | no |
| 8 | Required | Plausible | no |
| 11 | Required | Plausible | no |
| 12 | Required | Plausible | no |
| 13 | no | no | no |
| 14 | Required | Plausible | no |
| 15 | no | Plausible | no |
| 16 | no | Plausible | no |
| 17 | Required | Plausible | no |
| 18 | Required | Plausible | no |
| 19 | no | no | no |
| 20 | Required | Plausible | No |

Debater 1 also makes several assertions about other debaters' worldviews by specifying these constraints:
not (doesn't accept 4)
not (accepts 7)
not (accepts 19)
   The statement in the third constraint is something they don't presently know how to disprove, but they feel confident that anyone who believes it can be defeated. Anyone who violates the first two constraints can already be defeated, assuming debater 1's predictions of the observer are correct, but debater 1 wishes to speed up the debate by constructing attacks that, initially at least, assume that those constraints won't be violated.

A second debater, debater 2, believes that military spending should be increased. Wishing to advertise this to interested readers, they initially reveal that they accept statement 13. As other debaters, such as debater 1, attack debater 2 for this (described in detail shortly), debater 2 is forced to answer questions by including the above statements 1-8 and 11-20 in their worldview. Debater 2 is aware of the potential ambiguity in the meaning of statement 7. Instead of accepting statement 8 (which would only be true under a broad meaning of being “on the side of”), debater 2 enters two additional statements, statements 9 and 10 (listed above). They accept statement 10, which makes the same argument as statement 8, but only if statement 9 is accepted (that is, if this broad meaning is used). If the observer were asked whether it's possible to not accept statement 8, a reader who uses the meaning in statement 9 might answer no, causing debater 2 to be eliminated. So, in predicting the observer's beliefs, debater 2 must apply the “uncertain before reading” tag to statement 9, predicting that the observer will not require it, but that this prediction is only certain if the observer has read it. The tags that debater 2 applies to statements 1-20 are as follows according to Table 12.

TABLE 12

| Statement | Required? | Plausible? | Uncertain? | Assume? | Reveal? |
|---|---|---|---|---|---|
| 1 | no | Plausible | no | Assume | no |
| 2 | no | No | no | no | no |
| 3 | Required | Plausible | no | Assume | no |
| 4 | no | No | no | no | no |
| 5 | Required | Plausible | no | Assume | no |
| 6 | Required | Plausible | no | Assume | no |
| 7 | no | No | no | no | no |
| 8 | no | No | no | no | no |
| 9 | no | No | Uncertain | no | no |
| 10 | Required | Plausible | no | Assume | no |
| 11 | no | No | no | no | no |
| 12 | Required | Plausible | no | Assume | no |
| 13 | no | No | no | no | Reveal |
| 14 | Required | Plausible | no | Assume | no |
| 15 | no | Plausible | no | Assume | no |
| 16 | no | No | no | no | no |
| 17 | Required | Plausible | no | Assume | no |
| 18 | Required | Plausible | no | Assume | no |
| 19 | no | No | no | no | no |
| 20 | Required | Plausible | no | Assume | no |

The logical steps between statements 1-20 are automatically identified by the algorithm in Section 4 to be:
From 1 and 3 follows 2
From 5 and 6 follows 4
From 2 and 4 and 8 follows 7
From 9 and 10 follows 8
From 2 and 4 and 9 and 10 follows 7
From 7 and 11 and 12 follows 0
From 1 and 14 follows 13
From 15 and 16 and 17 follows 13
From 16 and 18 and 20 follows 19

Debater 2's worldview is automatically generated according to Table 13:

TABLE 13

| Statement | Accept? | Reason |
|---|---|---|
| 1 | Accept | assumed |
| 2 | Accept | 1, 3 |
| 3 | Accept | assumed |
| 4 | Accept | 5, 6 |
| 5 | Accept | assumed |
| 6 | Accept | assumed |
| 7 | no | |
| 8 | no | |
| 9 | no | |
| 10 | Accept | assumed |
| 11 | no | |
| 12 | Accept | assumed |
| 13 | Accept | 1, 14 |
| 14 | Accept | assumed |
| 15 | Accept | assumed |
| 16 | no | |
| 17 | Accept | assumed |
| 18 | Accept | assumed |
| 19 | no | |
| 20 | Accept | assumed |

With the debaters having applied their tags and entered their constraints, a reader performs a search for all worldviews that accept statement 13, which is true for debater 2. The system applies the algorithms described above to determine whether to initiate a debate between each pair of debaters, including debaters 1 and 2. If debater 1 were to decide whether to attack debater 2 in real life, they might reason as follows: “Debater 2 has revealed that they accept statement 13. What worldviews would justify statement 13? One possibility is that they argue statement 13 from statements 15 and 16. In this case, they must also accept statement 19, because it follows from required statement 18. I think I can eventually defeat anyone who accepts statement 19. The other possibility is that they argue statement 13 from statement 1, which would imply that they accept statement 2. They must also accept statement 4, since it follows from required statement 5. Therefore, by statement 8, they must accept statement 7, which I'm sure they don't. Even if they do, since they would also have to accept required statement 11, their beliefs would be contradictory. For both of these possibilities, they can be defeated, so I will attack them.”

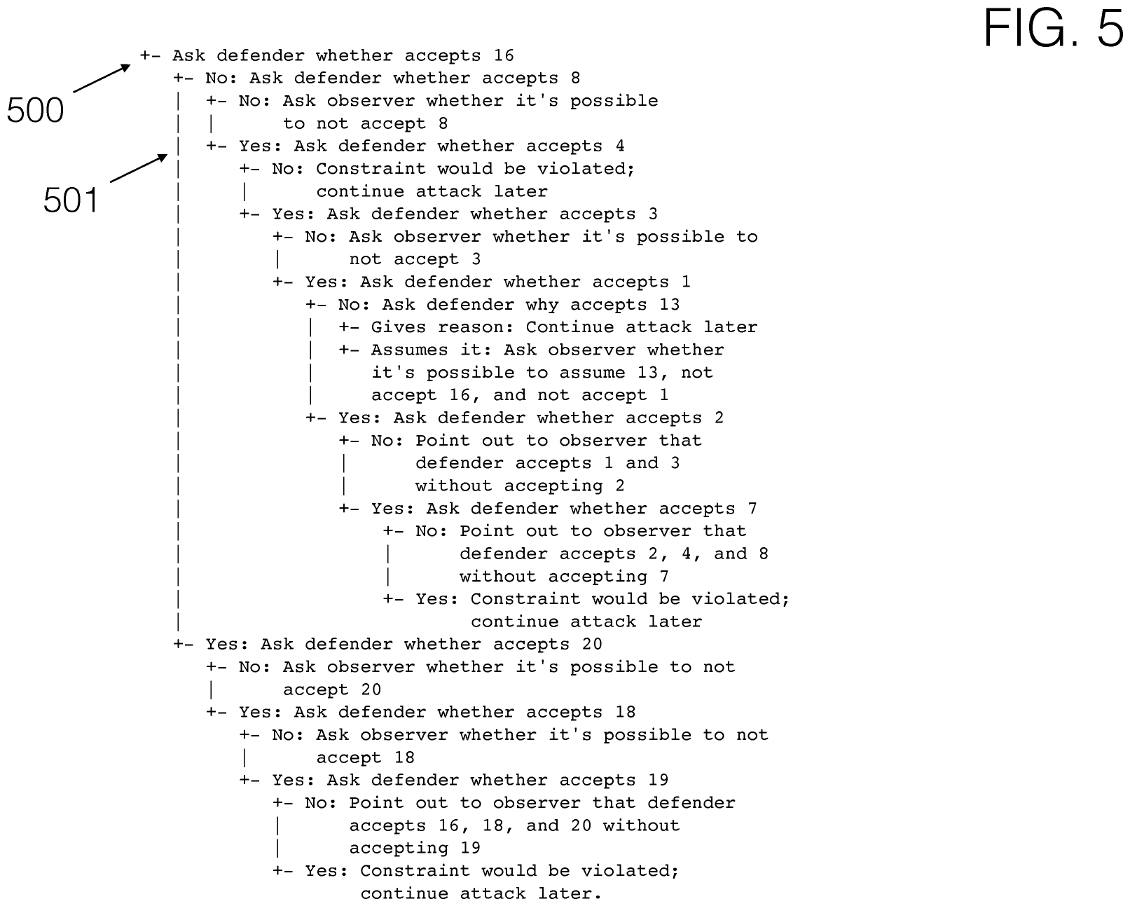

The algorithm follows essentially the same reasoning. Given that debater 2 accepts statement 13, it constructs the attack plan shown in FIG. 5, with debater 1 as the attacker and debater 2 as the defender. The nodes 500 show questions that the attacker will ask, with the edges 501 corresponding to the defender's possible answers. Every possible sequence of answers leads to a guaranteed defeat for the defender (assuming debater 1 is right). For example, if the defender accepts statements 2, 4, and 8 but doesn't accept statement 7, the defender would be defeated by the observer question, “Is it possible to have a worldview that accepts statements 2, 4, and 8 and doesn't accept statement 7?”, which the observer wouldn't even need to answer, because statement 7 follows logically from statements 2, 4, and 8. If the defender accepts statement 13 for no reason, doesn't accept statement 1, and doesn't accept statement 16, the defender would be defeated by the observer question, “Is it possible to have a worldview that assumes statement 13, doesn't accept statement 16, and doesn't accept statement 1?” The algorithm has included statements 1 and 16 in the observer question because, without them, the observer might think that the defender does accept statement 1 or 16, which would make it possible for them to assume statement 13. If the defender doesn't accept statement 4, debater 1's first constraint would be violated, which would cause a new attack plan to be constructed, one that would presumably ask the defender about statements 5 and 6 and defeat them if they don't accept both of them.

Since debater 1's attack plan leads to debater 2's defeat regardless of how debater 2 answers, the system initiates a simulated debate between the two debaters, with debater 1 as the attacker and debater 2 as the defender. In this simulated debate, the algorithms control the actions of both debaters, and the debate proceeds as follows:
Defender: I accept 13.
Attacker: Do you accept 16?
Defender: I don't accept 16.
Attacker: Do you accept 8?
Defender: I don't accept 8.
Defender: I don't accept 9.
Attacker asks observer: Is it possible to not accept 8?
Defender amends question by adding 9.

The algorithm controlling the defender volunteers that they don't accept statement 9 so that it can be included in an observer question the attacker asks about statement 8. In implementations where the defender's amendments are incorporated directly into observer questions, the observer question produced in this debate would be, “Is it possible to have a worldview that doesn't accept statement 8 and doesn't accept statement 9?” The answer to this question, which was generated algorithmically from the debaters' tags and constraints, distinguishes which debater is right.

Similar debates take place between other pairs of debaters. Among the observer questions displayed to the reader at the end will be the one from the above debate. Statements 8 and 9, as well as the statements they refer to, may be displayed along with the question. If the reader answers no to this question, the defender is defeated, the debate goes into state 4, and debater 2 is eliminated (for that reader). But debater 2 hopes that the reader, having been made aware by reading statement 9 that it's possible to not use the broad meaning of “on the side of” described in that statement, would therefore answer that it's also possible to not accept statement 8. (In the same way that the attacker wanted to mention statements 1 and 16 to prevent the reader from incorrectly thinking of an argument for statement 13, the defender mentions statement 9 to prevent the reader from incorrectly thinking of an argument for statement 8.)

Assuming the reader does answer yes to the observer question, the debate goes into state 5 and debater 1 is eliminated (for that reader). If debater 2 isn't eliminated in a different debate, the reader will see them listed as a remaining defender, and could conclude that it is possible to accept statement 13.

This example will be continued to illustrate the importance of the defender being able to attack the observer's requirements. It takes place in an implementation in which the defender's amendments to an observer question are asked first rather than being incorporated into the question. Suppose that the reader happens to enforce that statement 9 should be accepted, causing debater 2's worldview to accept statement 8 and therefore also statement 7. The algorithm controlling debater 1 now believes that debater 1 can defeat debater 2 by asking whether debater 2 accepts statement 11, which, with statement 7, implies a contradiction. Debater 2, however, does not believe that it's necessary to accept statement 11, even though by itself it sounds like it's obviously true. Because the reader is likely to require statement 11 when they read it, debater 2 needs to attack the observer's requirements to prevent this. So debater 2 enters four additional statements, whose logical structure is illustrated in FIG. 3C:
21. The US should not be on the side of any group with evil ideology.
22. {21 implies 11}
23. It was good that the US was on the side of the USSR in World War II.
24. {21 and 23 implies false}

They tag the new statements as follows, using the versions of the “required” and “plausible” tags that apply to both attacking other debaters and attacking the observer's requirements as shown in Table 14:

TABLE 14

| Statement | Required/plausible? | Uncertain? | Assume? | Reveal? |
|---|---|---|---|---|
| 21 | Maybe required, | Uncertain | no | no |
| | maybe plausible | | | |
| 22 | Required | No | Assume | no |
| 23 | Required | No | Assume | no |
| 24 | Required | No | Assume | no |

With the algorithm controlling debater 2 now using these new tags in addition to debater 2's previous tags, the debate between debater 1 and debater 2 proceeds as follows (starting from when the attacker has asked the defender about statement 7):
Defender: I accept 7.
Attacker: Do you accept 12?
Defender: I accept 12.
Attacker: Do you accept 11?
Defender: I don't accept 11.
Defender: I don't accept 21.
Attacker asks observer: Is it possible to not accept 11?
Defender amends question by adding 21.

The reader is first asked, “Is it possible to have a worldview that doesn't accept statement 21?” If the reader answers no, the system infers that statement 21 is part of the observer's requirements worldview. The system then automatically constructs an attack plan against the observer's requirements based on debater 2's tags. It initiates a debate between debater 2 and the reader, with debater 2 as the attacker and the reader as the defender and observer, which proceeds as follows:
Attacker: Is it possible to not accept 23?
Defender/Observer: No.
Attacker: Is it possible to not accept 24?
Defender/Observer: No.
Attacker: Is it possible to not accept “false”?
Defender/Observer: Yes (obviously).
Attacker points out that observer doesn't think it's possible to not accept 21, doesn't think it's possible to not accept 23, and doesn't think it's possible to not accept 24, yet does think that it's possible to not accept “false”.
   Upon reading this (and seeing what those statements say), the reader will presumably realize that their requirements are inconsistent, change their mind about statement 21, and direct the system to run the main debates again, which include the debate between debaters 1 and 2. This time, the reader would answer yes about not accepting statement 21. The original observer question would then be asked, with the reminder about statement 21: “Remembering that you said it's possible to not accept statement 21, is it possible to not accept statement 11?” Assuming statement 21 is the only argument that the reader knows for statement 11, they would answer yes, and debater 2 would avoid being defeated.

### EMBODIMENTS

Embodiment 1. A network-accessible system that adjudicates competing beliefs, the system determining whether an observer would consider a set of beliefs to be impossible by carrying out the following steps:

providing at least three roles for system users: 1) a defender that has beliefs that the defender asserts are possible to consistently hold; 2) an attacker that tries to demonstrate that the defender's beliefs are impossible to hold; 3) and observer that judges, within the system, whether the defender's beliefs are possible;

running a simulated debate comprising the following actions: receiving questions from the attacker directed to the defender about the defender's beliefs; receiving information revealed by the defender about the defender's beliefs; receiving an observer question from the attacker directed to the observer based on the defender's revealed beliefs about whether certain beliefs are impossible; communicating the observer question to the observer, wherein the defender has the option to add additional information about the defender's revealed beliefs to the observer question;

using information known about the observer's beliefs to determine how the observer would answer the observer question; and

using the observer's answer to the observer question to determine whether the observer would consider the beliefs that were revealed in the simulated debate to be impossible.

Embodiment 2. The system of embodiment 1, wherein the system hosts multiple debaters, further comprising:

providing a user called a reader;

filtering attacker and defender beliefs for a reader by a process comprising:

running simulated debates;

asking the reader the observer questions produced in simulated debates and storing the reader's answers; and

determining which beliefs an observer would consider impossible, using, for the system's knowledge of the observer's beliefs, the reader's stored answers.

Embodiment 3. The system of embodiment 2, wherein in determining which beliefs to eliminate in the determination step, the system criteria comprise:
(a) eliminating defender beliefs that are determined to be impossible based on reader answers;
(b) eliminating attackers that ask observer questions that fail to have the defender's beliefs determined to be impossible; and
(c) eliminating defenders that have not given an answer to a question being asked by more than some specified number of attackers that have not been eliminated.

Embodiment 4. The system of embodiment 2, further comprising a user called an observer predicter that makes predictions of the reader's answers to observer questions, wherein the predictions may be used to prioritize relevant observer questions.

Embodiment 5. The system of embodiment 2, wherein the system can also run simulated debates in which the reader performs the actions of the attacker or the defender.

Embodiment 6. The system of embodiment 1, further comprising representing a defender's beliefs as a worldview, wherein the worldview comprises
(a) a set of statements, each statement having a position, wherein the position is accepted or not accepted, wherein accepting a statement means that the defender believes the statement to be true; and
(b) for some accepted statements, a reason for the statement, wherein the reason comprises a set of other accepted statements that the defender believes implies the first statement, wherein accepted statements with a reason are called supported and accepted statements without a reason are called assumed;
wherein an attacker's questions to the defender comprise asking the defender's position on a statement or asking the defender's reason for an accepted statement.

Embodiment 7. The system of embodiment 6, wherein an observer question comprises asking whether it's possible to have a worldview that satisfies a list of conditions comprising (i) accepts a statement, (ii) does not accept a statement, (iii) assumes a statement, or (iv) accepts a statement for a particular reason.

Embodiment 8. The system of embodiment 6, wherein the defender's additions to an observer question are treated as separate questions to be asked individually first.

Embodiment 9. The system of embodiment 6, wherein the system can also run simulated debates in which debaters can attack a worldview comprising the reader's requirements and the reader performs the actions of the defender to defend the worldview.

Embodiment 10. The system of embodiment 6, wherein the system performs actions in a simulated debate for an attacker, the actions being specified by attacks, each attack comprising a condition on the defender's worldview and an action, the action comprising (i) accepts a statement, (ii) does not accept a statement, (iii) assumes a statement, or (iv) accepts a statement for a particular reason, and the system performs actions in a simulated debate for a defender, the actions being specified by a worldview and a list of defenses, each defense comprising an observer question and a list of statements to add to the observer question.

Embodiment 11. The system of embodiment 6, in which the system allows statements in text form and logical form; wherein the system has rules that define what logical form statements can be used and what constitutes a legal logical step;
and which requires that worldviews adhere to restrictions comprising:
(1) any statement that follows from accepted statements by a logical step is accepted;
(2) any statement with a reason follows from its reason by a logical step; and
(3) a statement that the system can determine to be false is not accepted;
wherein the conditions of an observer question comprise: (i) accepts a statement, (ii) does not accept a statement, (iii) assumes a statement, or (iv) supports a statement.

Embodiment 12. The system of embodiment 11, wherein the system automatically generates defenders' worldviews from tags that a defender applies to statements, those tags comprising:
(1) whether the defender assumes the statement;
(2) whether to initially reveal the defender's position on the statement.

Embodiment 13. The system of embodiment 11, wherein the system uses logical form statements that are implication statements, wherein an implication statement comprises a set of premises and a conclusion, and is true when the premises imply the conclusion; and legal logical steps come from combining one implication statement with other implication statements whose conclusions are premises of the first implication.

Embodiment 14. The system of embodiment 11, wherein the system performs actions in a simulated debate for an attacker, wherein those actions are algorithmically determined from constraints specified by the attacker, wherein a constraint comprises a set of conditions that the attacker asserts can't all be true of a worldview, each condition being that the worldview (i) accepts a statement, (ii) doesn't accept a statement, (iii) assumes a statement, or (iv) supports a statement.

Embodiment 15. The system of embodiment 14, wherein the system automatically determines the actions to perform in a simulated debate for an attacker using an algorithm that begins with the defender's revealed worldview and recursively determines what conclusions must be true about the worldview until arriving at an inconsistency.

Embodiment 16. The system of embodiment 14, wherein the system performs actions in a simulated debate for an attacker, defender, or observer predicter, wherein those actions are automatically determined from predictions of the observer's beliefs derived from tags that the debater applies to statements, wherein the tags comprise:

a tag that indicates required arguments;

a tag that indicates optional arguments; and

one or more tags indicating uncertainty if the statement isn't read;

wherein:

the observer is predicted to believe that the arguments defenders are required to believe are arguments from statements to which the first tag is applied;

the observer is predicted to believe that the arguments defenders may optionally believe are arguments from statements to which the second tag is applied; and

the tags applied to a statement to which a tag indicating uncertainty is applied may not accurately predict the beliefs of an observer who hasn't read the statement.

While the invention has been described with reference to the embodiments above, a person of ordinary skill in the art would understand that various changes or modifications may be made thereto without departing from the scope of the claims.

I claim:

1. A network-accessible system that adjudicates competing beliefs, the system determining whether an observer would consider a set of beliefs to be impossible by carrying out the following steps:
providing at least three roles for system users: 1) a defender that has beliefs that the defender asserts are possible to consistently hold; 2) an attacker that tries to demonstrate that the defender's beliefs are impossible to hold; 3) and observer that judges, within the system, whether the defender's beliefs are possible;
running a simulated debate comprising the following actions: receiving questions from the attacker directed to the defender about the defender's beliefs; receiving information revealed by the defender about the defender's beliefs; receiving an observer question from the attacker directed to the observer based on the defender's revealed beliefs about whether certain beliefs are impossible; communicating the observer question to the observer, wherein the defender has an option to add additional information about the defender's revealed beliefs to the observer question;
using information known about the observer's beliefs to determine how the observer would answer the observer question; and
using the observer's answer to the observer question to determine whether the observer would consider the beliefs that were revealed in the simulated debate to be impossible.

2. The system of claim 1, wherein the system hosts multiple debaters, further comprising:
providing a user called a reader;
filtering attacker and defender beliefs for a reader by a process comprising:
running simulated debates;
asking the reader the observer questions produced in simulated debates and storing the reader's answers; and
determining which beliefs an observer would consider impossible, using, for system knowledge of the observer's beliefs, the reader's stored answers.

3. The system of claim 2, wherein in determining which beliefs to eliminate in the determination step, the system applies criteria comprising:
(a) eliminating defender beliefs that are determined to be impossible based on reader answers;
(b) eliminating attackers that ask observer questions that fail to have the defender's beliefs determined to be impossible; and
(c) eliminating defenders that have not given an answer to a question being asked by more than some specified number of attackers that have not been eliminated.

4. The system of claim 2, further comprising a user called an observer predicter that makes predictions of the reader's answers to observer questions, wherein the predictions may be used to prioritize relevant observer questions.

5. The system of claim 2, wherein the system can also run simulated debates in which the reader performs the actions of the attacker or the defender.

6. The system of claim 1, further comprising representing a defender's beliefs as a worldview, wherein the worldview comprises:
(a) a set of statements, each statement having a position, wherein the position is accepted or not accepted, wherein accepting a statement means that the defender believes the statement to be true; and
(b) for some accepted statements, a reason for a first statement, wherein the reason comprises a set of other accepted statements that the defender believes implies the first statement, wherein accepted statements with a reason are called supported and accepted statements without a reason are called assumed;
wherein an attacker's questions to the defender comprise asking the defender's position on a statement or asking the defender's reason for an accepted statement.

7. The system of claim 6, wherein an observer question comprises asking whether it's possible to have a worldview that satisfies a list of conditions comprising: (i) accepts a statement, (ii) does not accept a statement, (iii) assumes a statement, or (iv) accepts a statement for a particular reason.

8. The system of claim 6, wherein the defender's additions to an observer question are treated as separate questions to be asked individually first.

9. The system of claim 6, wherein the system can also run simulated debates in which debaters can attack a worldview comprising reader's requirements and the reader performs the actions of the defender to defend the worldview.

10. The system of claim 6, wherein the system performs actions in a simulated debate for an attacker, the actions being specified by attacks, each attack comprising a condition on the defender's worldview and an action, the action comprising (i) accepts a statement, (ii) does not accept a statement, (iii) assumes a statement, or (iv) accepts a statement for a particular reason, and the system performs actions in a simulated debate for a defender, the actions being specified by a worldview and a list of defenses, each defense comprising an observer question and a list of statements to add to the observer question.

11. The system of claim 6, in which the system allows statements in text form and logical form; wherein the system has rules that define what logical form statements can be used and what constitutes a legal logical step;
and which requires that worldviews adhere to restrictions comprising:
(1) any statement that follows from accepted statements by a logical step is accepted;
(2) any statement with a reason follows from its reason by a logical step; and
(3) a statement that the system can determine to be false is not accepted;
wherein conditions of an observer question comprise: (i) accepts a statement, (ii) does not accept a statement, (iii) assumes a statement, or (iv) supports a statement.

12. The system of claim 11, wherein the system automatically generates defenders' worldviews from tags that a defender applies to statements, those tags comprising:
(1) whether the defender assumes the statement;
(2) whether to initially reveal the defender's position on the statement.

13. The system of claim 11, wherein the system uses logical form statements that are implication statements, wherein an implication statement comprises a set of premises and a conclusion, and is true when the premises imply the conclusion; and legal logical steps come from combining one implication statement with other implication statements whose conclusions are premises of the one implication statement.

14. The system of claim 11, wherein the system performs actions in a simulated debate for an attacker, wherein those actions are algorithmically determined from constraints specified by the attacker, wherein a constraint comprises a set of conditions that the attacker asserts can't all be true of a worldview, each condition being that the worldview (i) accepts a statement, (ii) doesn't accept a statement, (iii) assumes a statement, or (iv) supports a statement.

15. The system of claim 14, wherein the system automatically determines the actions to perform in a simulated debate for an attacker using an algorithm that begins with a defender's revealed worldview and recursively determines what conclusions must be true about the worldview until arriving at an inconsistency.

16. The system of claim 14, wherein the system performs actions in a simulated debate for an attacker, defender, or observer predicter, wherein those actions are automatically determined from predictions of the observer's beliefs derived from tags that the debater applies to statements, wherein the tags comprise:
a tag that indicates required arguments;
a tag that indicates optional arguments; and
one or more tags indicating uncertainty if the statement isn't read;
wherein:
the observer is predicted to believe that the arguments defenders are required to believe are arguments from statements to which a first tag is applied;
the observer is predicted to believe that the arguments defenders may optionally believe are arguments from statements to which a second tag is applied; and
the tags applied to a statement to which a tag indicating uncertainty is applied may not accurately predict the beliefs of an observer who hasn't read the statement.
